(19) United States
(12) Patent Application Publication
(10) Pub. No.: US 2015/0351101 A1
(43) Pub. Date: Dec. 3, 2015

(54) COMMUNICATION SYSTEM, NODE, CONTROLLER, COMMUNICATION METHOD AND PROGRAM

(71) Applicant: NEC CORPORATION, Minato-ku, Tokyo (JP)

(72) Inventors: Kazushi SUGYOU, Tokyo (JP); Yasunobu CHIBA, Yasunobu (JP)

(73) Assignee: NEC CORPORATION, Minato-ku, Tokyo (JP)

(21) Appl. No.: 14/761,582

(22) PCT Filed: Jan. 17, 2014
(86) PCT No.: PCT/JP2014/050790

§ 371 Date: Jul. 16, 2015

(30) Foreign Application Priority Data
Jan. 18, 2013 (JP) 2013-007238

(51) Int. Cl. H04W 72/04

(52) U.S. Cl. CPC H04W 72/0493; H04L 2212/00

(57) ABSTRACT

A communication system includes: a computational resource(s) allocated to a user; and an allocation unit that allocates at least one of a plurality of communication schemes to the computational resource(s) based on a requested condition concerning a service rendered to the user via the computational resource(s).

### REFERENCE TO RELATED APPLICATIONS

The present Application asserts priority rights based on a Patent Application 2013-007238filed in Japan on Jan. 18, 2013, the total contents thereof being incorporated by reference into the present Application.

### TECHNICAL FIELD

This invention relates to a communication system, a node, a controller, a communication method and a program and, in particular, to a communication system, a node, a controller, a communication method and a program configured for processing a packet received.

### BACKGROUND

Recently, such a technique of logically constructing a plurality of networks, separated from one another over a physical network, has been proposed. This logically constructed network is referred to below as a virtual network. In constructing a virtual network B over a certain network A, the network A is sometimes termed an underlay network and the virtual network B an overlay network.

Patent Literature 1 describes a technique of constructing a DC (Data Center) by the VLAN (Virtual Local Area Network). For example, in Patent Literature 1, a network segment is formed from one virtual tenant to another, using the VLAN, in order to construct client-based virtual tenants in the DC (Data Center).

Patent Literature 2 discloses a technique for effecting load balancing for service rendering servers in a computerized system.

### CITATION LIST

### Patent Literature

### Patent Literature 1:

WO2012/035861 A1

### Patent Literature 2:

Japanese Patent Kokai Publication No. JP2011-170718A

### SUMMARY

### Technical Problem

In constructing a virtual network, there are cases wherein communication processing, such as packet encapsulation, is needed. In using a virtual network, there is a possibility that, because of the necessity to perform additional communication processing for constructing the virtual network, the performance or property of communication becomes worse than in directly using a physical network.

Patent Literature 1 discloses using the VLAN to construct a virtual network, but fails to disclose the technique to suppress the performance or property of communication from becoming deteriorated due to construction of the virtual network.

Patent Literature 2 discloses a technique for effecting load balancing of the service rendering servers, but again fails to disclose the technique to suppress the performance or property of communication from becoming deteriorated due to construction of the virtual network.

It is an object of the present invention to provide a communication system, a node, a controller, a communication method and a program configured to overcome the above mentioned problems.

### Solution to Problem

A communication system according to the present invention comprises: a computational resource(s) allocated to a user; and allocation means that allocates at least one of a plurality of communication schemes to the computational resource(s) based on a requested condition concerning a service rendered to the user via the computational resource(s).

A node according to the present invention comprises: identification means that identifies a requested condition concerning a service rendered to a user via a computational resource(s) allocated to the user; and control means that allocates at least one of a plurality of communication schemes to the computational resource(s) based on the requested condition.

A controller according to the present invention comprises: allocation means that allocates at least one of a plurality of communication schemes to a computational resource(s), allocated to a user, based on a requested condition concerning a service rendered to the user via the computational resource(s); and communication means that informs a node connected to the computational resource(s) about the allocated communication scheme.

A communication method according to the present invention comprises: identifying a requested condition concerning a service rendered to a user via a computational resource(s) allocated to the user; and allocating at least one of a plurality of communication schemes to the computational resource(s) based on the requested condition.

A communication method according to the present invention comprises: allocating at least one of a plurality of communication schemes to a computational resource(s) allocated to a user based on a requested condition concerning a service rendered to the user via the computational resource(s); and informing a node connected to the computational resource(s) about the allocated communication scheme.

A program according to the present invention causes a node, connected to a computational resource(s) allocated to a user, to execute: identifying a requested condition concerning a service rendered to the user via the computational resource(s); and allocating at least one of a plurality of communication schemes to the computational resource(s) based on the requested condition.

A program according to the present invention causes a controller for controlling a node to execute: based on a requested condition concerning a service rendered to a user via a computational resource(s) allocated to the user, allocating at least one of a plurality of communication schemes to the computational resource(s); and informing the node connected to the computational resource(s) about the allocated communication scheme.

### Advantageous Effects of Invention

According to the present invention, it is possible to provide a user with a communication environment having the performance capable of satisfying the user's requested condition.

### BRIEF DESCRIPTION OF THE DRAWINGS

FIG. 1 is a schematic block diagram showing an example configuration of a communication system according to a first exemplary embodiment.

FIG. 2 is another schematic block diagram showing an example configuration of a communication system according to the first exemplary embodiment.

FIG. 3(A) and FIG. 3(B) are tabulated views showing instances of the information held by an allocation unit 1 of the first exemplary embodiment.

FIG. 4 is a schematic block diagram showing an instance of the manner of allocating computational resources to the communication schemes according to the first exemplary embodiment.

FIG. 5 is a schematic block diagram showing an example configuration of a communication system according to a second exemplary embodiment.

FIG. 6 is a tabulated view showing an instance of the relationship of correspondence between the networks and the communication schemes for the second exemplary embodiment.

FIG. 7 is a block diagram showing an example configuration of an allocation unit 1 of the second exemplary embodiment.

FIG. 8 is a tabulated view showing an instance of a user DB (Database) 14 of the second exemplary embodiment.

FIG. 9 is a tabulated view showing an instance of a policy DB 13 of the second exemplary embodiment.

FIG. 10 is a flowchart showing a flow of operations of the second exemplary embodiment.

FIG. 11 is a flowchart showing a flow of operations of a third exemplary embodiment.

FIG. 12 is a flowchart showing another flow of operations of the third exemplary embodiment.

FIG. 13 is a schematic block diagram showing an instance of the manner of allocating computational resources to the communication schemes according to the third exemplary embodiment.

FIG. 14 is a flowchart showing still another flow of operations of the third exemplary embodiment.

FIG. 15 is a tabulated view showing the manner of updating the user DB 14 according to the third exemplary embodiment.

FIG. 16 is a schematic block diagram showing another instance of the manner of allocating computational resources to the communication schemes according to the third exemplary embodiment.

FIG. 17 is a schematic block diagram showing another instance of the manner of allocating computational resources to the communication schemes according to the third exemplary embodiment.

FIG. 18 is a flowchart showing still another flow of operations of the third exemplary embodiment.

FIG. 19 is a schematic block diagram showing an example configuration of a communication system according to a fourth exemplary embodiment.

FIG. 20 is a schematic block diagram showing an example configuration of a controller 4 according to the fourth exemplary embodiment.

FIG. 21(A) and FIG. 21(B) are tabulated view showing a policy DB 43 according to the fourth exemplary embodiment.

FIG. 22 is a tabulated view showing a user DB 44 according to the fourth exemplary embodiment.

FIG. 23 is a block diagram showing an example configuration of a packet processor 5 according to the fourth exemplary embodiment.

FIG. 24 is a tabulated view showing an instance of a packet forwarding table 53 according to the fourth exemplary embodiment.

FIG. 25 is a flowchart showing a flow of operations according to the fourth exemplary embodiment.

FIG. 26 is a schematic block diagram showing an example configuration of a communication system according to a fifth exemplary embodiment.

FIG. 27 is a block diagram showing an example configuration of an OFC 400 according to the fifth exemplary embodiment.

FIG. 28 is a block diagram showing an example configuration of an OFS 500 according to the fifth exemplary embodiment.

FIG. 29 is a tabulated view showing a flow table 503 according to the fifth exemplary embodiment.

FIG. 30 is a sequence chart showing a flow of operations according to the fifth exemplary embodiment.

FIG. 31 is a block diagram showing an example configuration of a communication system according to a sixth exemplary embodiment.

FIG. 32 is another schematic block diagram showing an example configuration of the communication system according to the sixth exemplary embodiment.

### DESCRIPTION OF EMBODIMENTS

Certain preferred exemplary embodiments of the present invention will now be described with reference to the drawings.

### First Exemplary Embodiment

### Summary:

A first exemplary embodiment of the present invention will be summarized. In the first exemplary embodiment, at least one of a plurality of communication schemes is allocated to computational resources based on a requested condition concerning a service rendered to a user via the computational resources. This processing provides for communication complying with the requested condition regarding the service rendered.

### Details:

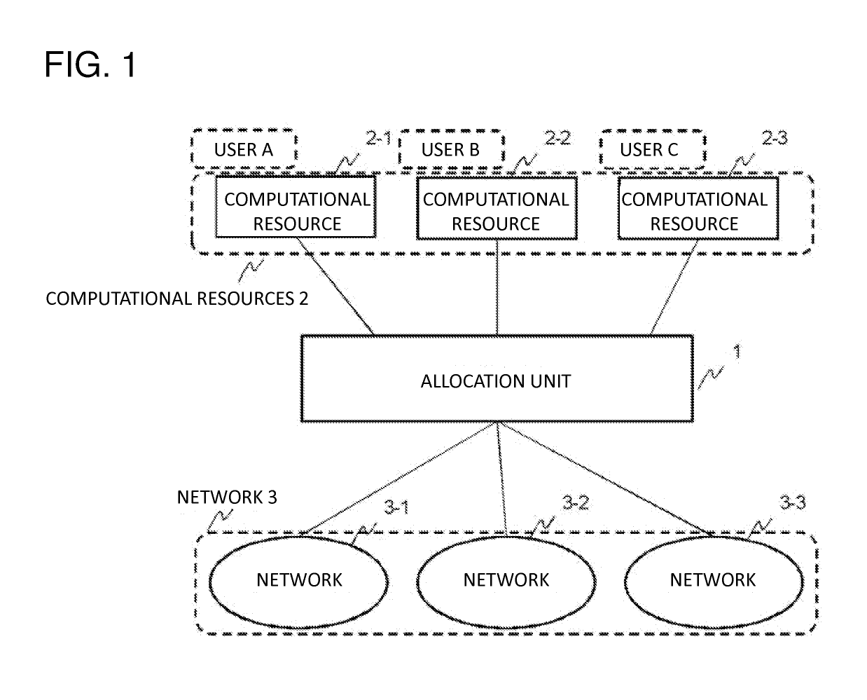

The first exemplary embodiment of the present invention will now be described. FIG. 1 shows, for example, a configuration of the communication system of the first exemplary embodiment. Referring to FIG. 1, the communication system includes an allocation unit 1, computational resources 2 and a network 3. In an instance of FIG. 1, the computational resources 2 include 1 a computational resource 2-1, a computational resource 2-2 and a computational resource 2-3. The network 3 includes a network 3-1, a network 3-2 and a network 3-3. In the next following and ensuing description, if it is not intended to make distinction between the individual computational resources, each of the computational resources 2-1, 2-2 and 2-3 is globally termed the computational resources 2. In similar manner, if it is not intended to make distinction between the individual networks, each of the networks 3-1, 3-2 and 3-3 is globally termed the network 3. The communication system is e.g., a data center.

The networks 3 may encompass networks with different communication schemes. For example, the network 3-1 and the network 3-2 may be networks of respective different communication schemes. The communication scheme may, for example, be a communication protocol exemplified by Ethernet (registered trademark), or a communication protocol constructing a virtual network, such as VLAN (Virtual Local Area Network), L2TP (Layer 2 Tunneling Protocol) or Ethernet IP. Viz., with the communication system, it is possible to make up the networks 3 by a plurality of communication schemes. For example, with the communication system, it is possible to make up a virtual network environment by any of the above mentioned multiple communication schemes.

The computational resources 2 are resources used for carrying out the processing performed on e.g., a server or a computer, and are allocated to a user(s). The user(s) exploits services rendered via the computational resources 2 allocated. In the instance of FIG. 1, a user A uses the computational resource 2-1, a user B the computational resource 2-2 and the user C the computational resource 2-3. The user(s) may use the allocated computational resources 2 to carry out an application associated with a certain service to benefit from the service. In the instance of FIG. 1, a communication concerning the service exploited by the user of the computational resources 2 has been brought into existence in the network 3.

The allocation unit 1 allocates at least one of the multiple communication schemes to the computational resources in response to a value of the service-related requested condition provided via the computational resources 2. Viz., based on the requested condition, the allocation unit 1 allocates at least one of multiple networks 3 of different communication schemes to the computational resources. The allocation unit 1 is equipped e.g., at a node provided on the communication system.

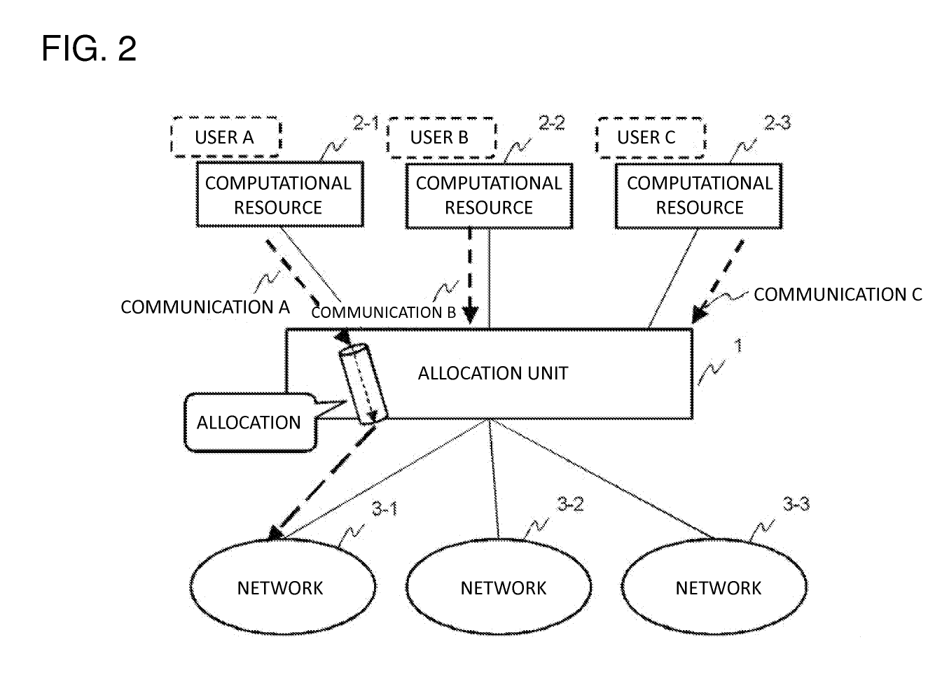

FIG. 2 schematically shows the operation of the allocation unit 1. In an instance of FIG. 2, a communication A originates from the computational resource 2-1, a communication B from the computational resource 2-2 and a communication C from the computational resource 2-3. In the instance of FIG. 2, the allocation unit 1 allocates the communication scheme of the network 3-1 to the computational resource 2-1 destined for the user A. In accordance with the allocation, the computational resource 2-1 carries out the communication in accordance with the communication scheme of the network 3-1 (communication A of FIG. 2).

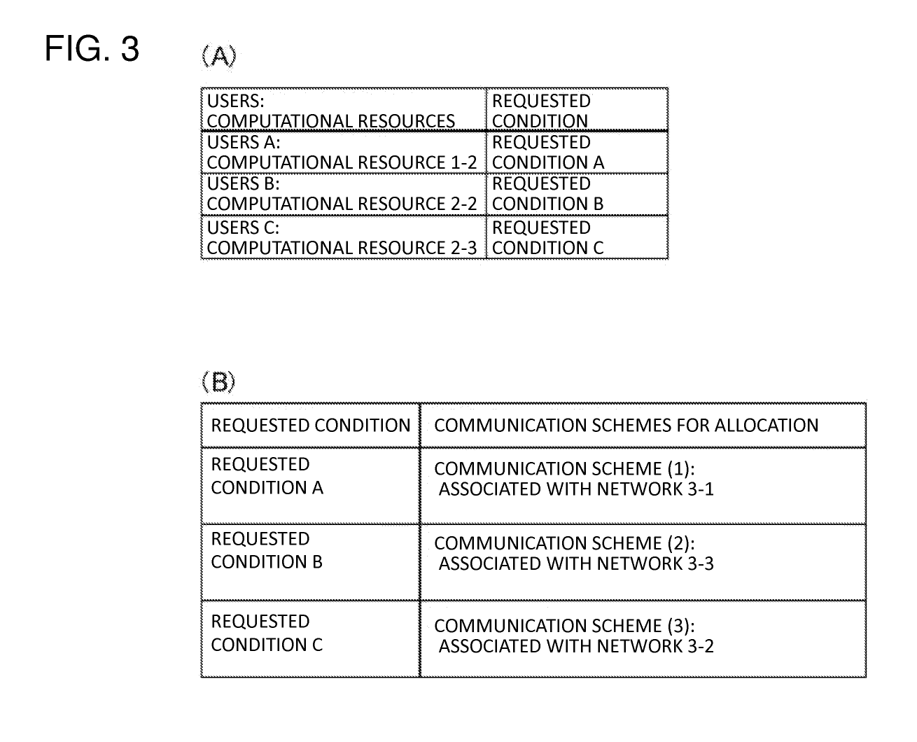

The allocation unit 1 is storing the information shown for example in FIG. 3(A) and FIG. 3(B). FIG. 3(A) shows the relationship of correspondence between the computational resources allocated to each user and the requested condition. For example, the computational resource 2-1, allocated to the user A, are associated with the requested condition “A.”

FIG. 3(B) shows communication schemes allocated in accordance with the requested condition. For example, the communication scheme (1) of the network 3-1 is allocated to the requested condition “A.”

By the “requested condition” is meant e.g., SLA (Service Level Agreement) which is determined from user to user. For example, a user pays an amount consistent with the requested condition to an operator of the communication system to benefit from services under conditions consistent with the amounts paid. Concrete examples of the SLA include communication bandwidths or throughputs, guaranteed for the user, a line speed, an average time delay in a network, an upper limit of the quantity of communication, average time delay in a network, an activity ratio and a packet loss ratio.

By the way, it is not strictly necessary for the allocation unit 1 to retain the information concerning the relationship of correspondence between the requested condition and the communication schemes such as is shown in FIG. 3(B). For example, the allocation unit 1 compares a value of performance requested by the requested condition, such as throughput, to a value of performance of each of the communication schemes, and allocates the communication scheme, out of the multiple communication schemes, which is able to satisfy the requested condition, to the computational resources. For example, the allocation unit 1 allocates the communication scheme, out of the multiple communication schemes, which will achieve an optimum value of performance, to the computational resources. It is presumed that the allocation unit 1 retains the values of performance, such as those of the communication bandwidth or throughput, from one communication scheme to another.

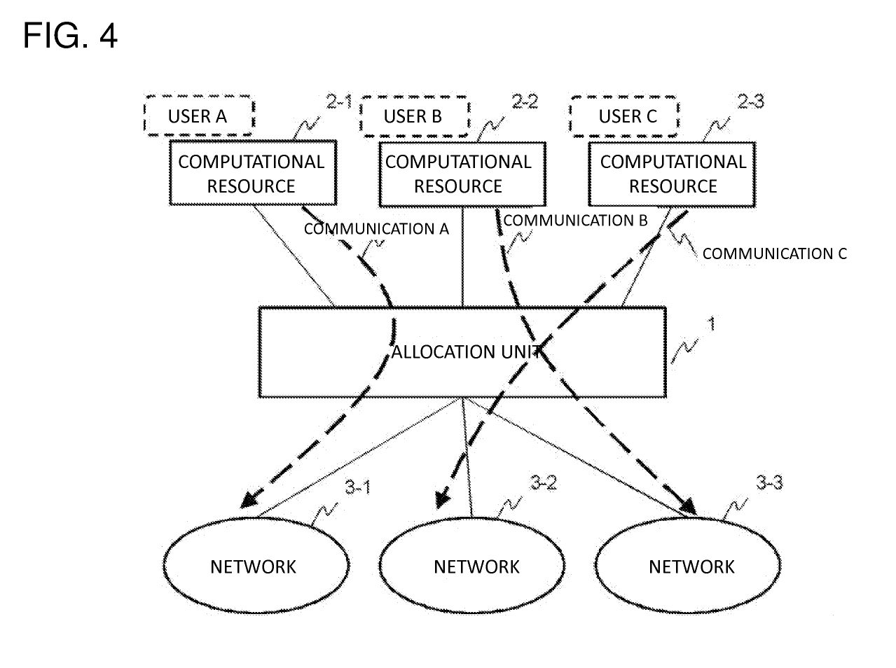

The allocation unit 1 causes the computational resources to be associated with the networks, as shown for example in FIG. 4. For example, the allocation unit 1 allocates the communication scheme (1), associated with the network 3-1, to the computational resource 2-1, while allocating the communication scheme (3), associated with the network 3-3, to the computational resource 2-2, and allocating the communication scheme (2), associated with the network 3-2, to the computational resource 2-3. The respective communication resources carry out the communications (communications A, B and C in the drawing) in accordance with the communication schemes allocated.

It may be seen from above that, in accordance with the first exemplary embodiment, in which an optimum communication scheme may be allocated to the computational resources in compliance with the requested condition for services, it is possible to provide a user with a communication environment of the performance that satisfies the user's requested condition. For example, in accordance with the present invention, optimum communication schemes may be allocated to the computational resources, so that, even in case communication is carried out by a virtual network, it is possible to provide the user with the virtual network environment that will satisfy his/her requested condition.

### Second Exemplary Embodiment

A second exemplary embodiment of the present invention will now be described with reference to the drawings. In the second exemplary embodiment, the allocation unit 1 is storing certain policies concerning the manner of allocation of the networks 3. The allocation unit 1 decides the communication scheme to be allocated to the computational resources in accordance with the policies.

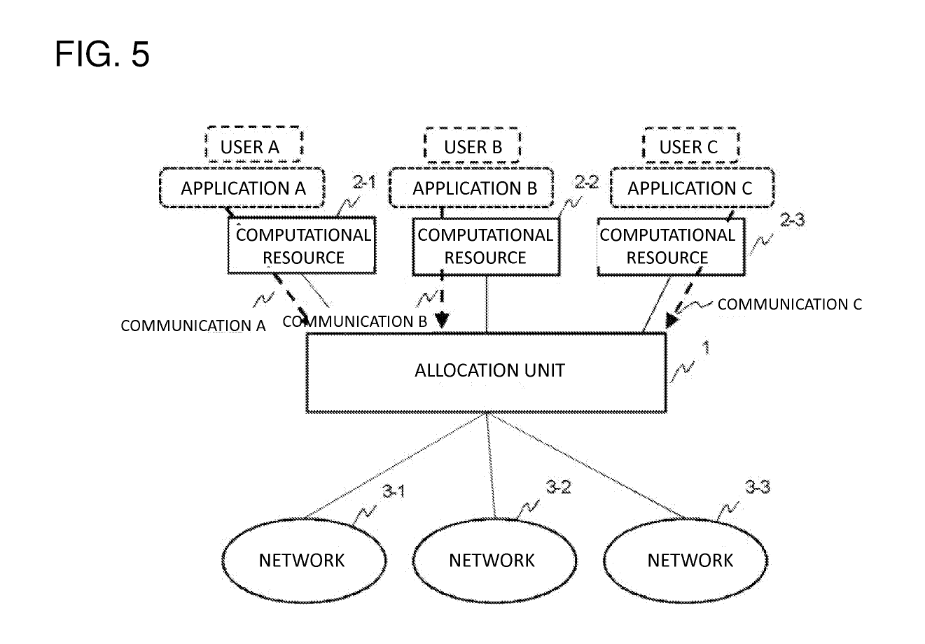

FIG. 5 is a schematic view showing an example configuration of the second exemplary embodiment. Since the basic configuration is similar to that of the first exemplary embodiment, detailed description is not made of the components indicated by the same reference numerals as those of the previous exemplary embodiment.

FIG. 5 includes an allocation unit 1, computational resources 2 and a network 3. The computational resources 2 may, for example, be a VM (Virtual Machine) running on a given server. In an instance of FIG. 5, it is assumed that each user is exploiting an application using each of the computational resources 2. Specifically, the user A is exploiting an application A using a computational resource 2-1, while the user B is exploiting an application B using a computational resource 2-2 and the user C is exploiting an application C using a computational resource 2-3. A communication originates from each of the computational resources 2 as a result of exploitation of each application. As in the first exemplary embodiment, it is assumed that the requested condition is set from one user to another. As typical of the requested condition is SLA explained in connection with the first exemplary embodiment.

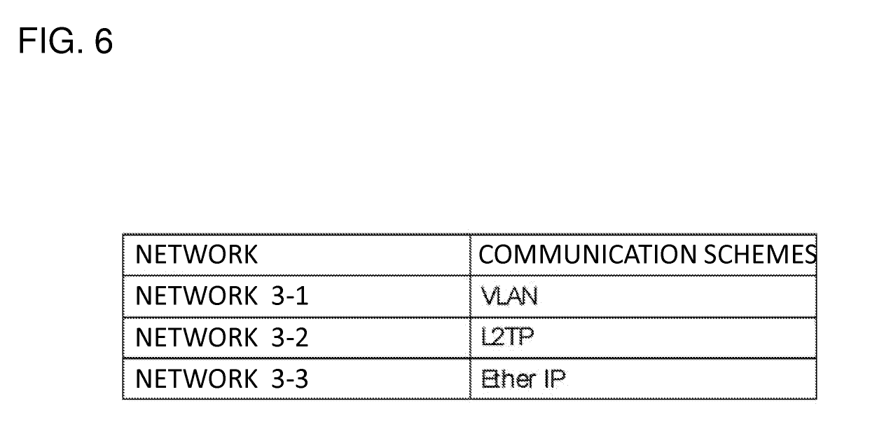

FIG. 6 shows example communication schemes of the network 3. In an instance of FIG. 6, the communication scheme of the network 3-1 is V-LAN. Likewise, the communication scheme of the network 3-2 is L2TP (Layer 2 Tunneling Protocol) and that of the network 3-3 is Ethernet IP. The network 3 may use a communication scheme in which a virtual network is constructed over a physical network, as shown in the instance of FIG. 6. A variety of tunneling protocols may be used in the communication schemes of the network 3. For example, GRE (Generic Routing Encapsulation), NVGRE (Network Virtualization using GRE) or IPsec (security architecture for Internet Protocol) may be used.

The communication scheme of the network 3 is not limited to one making up the above mentioned virtual network (overlay network) but may also be one making up a physical network (underlay network). A virtual network is in need not only of the processing to exploit a physical network but also of packet processing complying with the communication scheme that makes up the above mentioned virtual network. In VLAN, for example, it is necessary to add a VLAN tag in a packet. In GRE, it is necessary to encapsulate a packet. However, in a physical network, since no packet processing, requested to make up a virtual network, is needed, there is no overhead to communication otherwise imposed by the computational resources. Thus, if a virtual network is used, it is necessary to provide an overhead due to the above mentioned additional processing. Thus, in a communication scheme that uses the virtual network, in which it is necessary to provide the overhead due to the above mentioned additional processing, there is a possibility that the requested condition cannot be met. If the requested condition cannot be met with the communication scheme employing the virtual network, the allocation unit 1 allocates a communication scheme associated with the physical network to the computational resources.

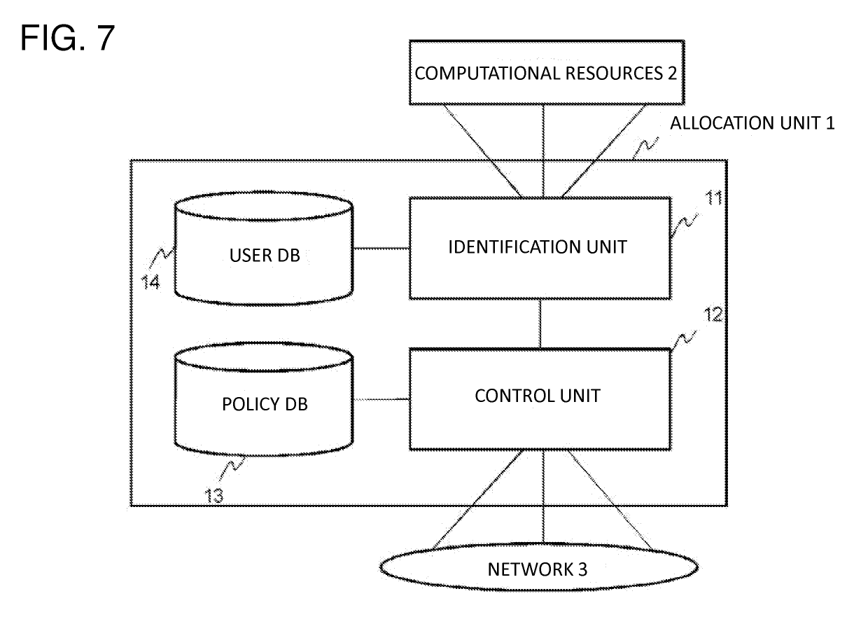

FIG. 7 depicts a schematic view showing a configuration of the allocation unit 1 in the second exemplary embodiment. Referring to FIG. 7, the allocation unit 1 includes an identification unit 11, a control unit 12, a policy DB (Database) 13 and a user DB 14. The allocation unit 1 of FIG. 7 differs from the allocation unit 1 (FIG. 5) of the first exemplary embodiment in including the policy DB 13 and the user DB 14.

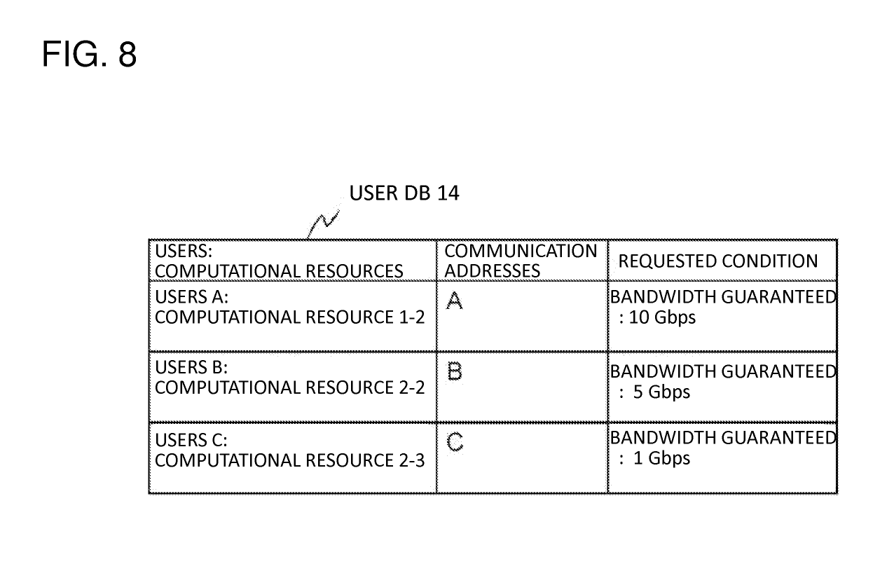

Referring to FIG. 8, the user DB 14 is storing the requested condition associated with the computational resources allocated to the user and the communication addresses of the respective computational resources 2. FIG. 8 shows the user DB 14 for such a case where the requested condition is “the bandwidth guarantee.” In an instance of FIG. 8, the content stored in the user DB 14 includes the communication address of the computational resource 2-1 destined for the user A being A and the requested condition destined for the user A being the guaranteed bandwidth of 10 Gbps. By the communication address is meant e.g., a source MAC (Media Access Control) address or a source IP address. The computational resources are running e.g., on a server, with the communication address being a MAC address or an IP address of such server.

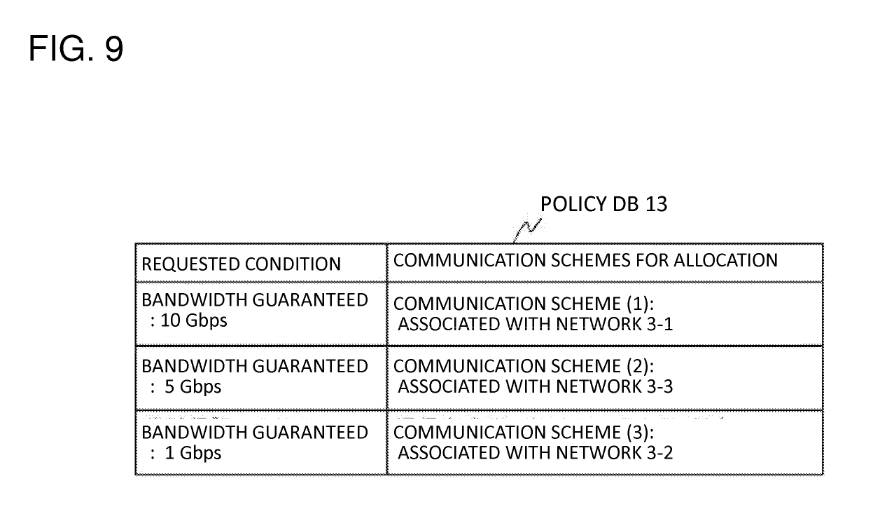

The policy DB 13 is holding e.g., the policies exemplified in FIG. 9. The policies entered in FIG. 9 stipulate the communication schemes to be allocated for such a case where the requested condition is “the bandwidth guarantee.” For example, the control unit 12 allocates a communication scheme capable of guaranteeing the bandwidth of 10 Gbps to the computational resources destined for the user for whom the bandwidth of 10 Gbps is guaranteed.

The requested condition need not be of a single sort but may also be of a plurality of different sorts combined together. For example, the requested condition may be the guaranteed bandwidth being 10 Gbps and an upper limit of the quantity of communication being 500 GB per day. Moreover, the policies set in the policy DB 13 do not necessarily have to be those including the above mentioned two sorts of the requested condition. For example, the policies in which the communication schemes to be allocated may be decided in dependence upon the average time delay, activity ratio or the packet loss ratio within the network as guaranteed for the user.

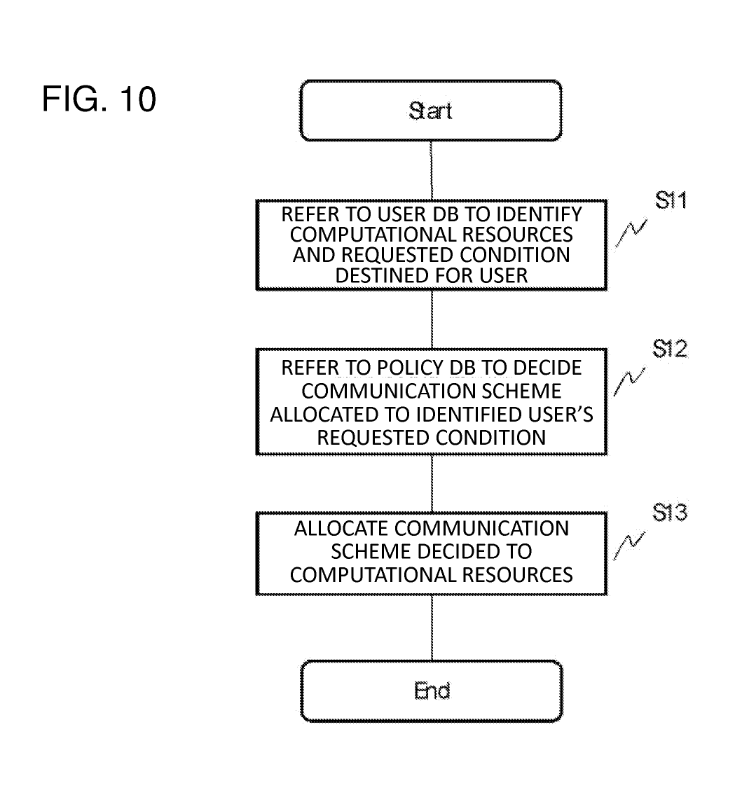

The operation of the allocation unit 1 will be explained with reference to the flowchart of FIG. 10. Initially, the identification unit 11 identifies the computational resources and the requested condition destined for the user (step S11). For example, the identification unit 11 searches the user DB 14, shown for example in FIG. 8, for the computational resources having a communication address corresponding to the communication address contained in a packet received. The identification unit 11 also specifies, from the user DB 14 shown in FIG. 8, the requested condition destined for the user searched. For example, if the communication address “A” is contained in the received packet, the identification unit 11 recognizes that the packet received is that from the computational resource 2-1 destined for the user A. In this case, the identification unit 11 finds that the requested condition destined for the user A is the bandwidth guarantee of 10 Gbps.

The control unit 12 then references the policy DB 13 to decide on the communication scheme associated with the requested condition specified by the identification unit 11 (step S12). It is now assumed that the identification unit 11 has recognized, from the user DB 14 shown for example in FIG. 8, the requested condition that is destined for the user A and which is “the bandwidth guarantee of 10 Gbps.” In this case, the control unit 12 references the policy DB 13, shown in FIG. 9, to decide that, in accordance with the requested condition that is destined for the user and which is “the bandwidth guarantee of 10 Gbps,” the communication scheme (1), capable of guaranteeing the bandwidth of 10 Gbps, is to be allocated to the computational resource 2-1.

The control unit 12 then allocates the communication scheme, decided in the step S12, to the computational resources (step S13).

After allocation of the communication scheme to the computational resources, the operations conforming to respective communication schemes are performed to carry out the communication. If the communication scheme allocated is such a one that makes up a virtual network, the control unit 12 allows carrying out processing for encapsulation, tagging or the like, which is needed for communication mediated by the virtual network. In more detail, for a packet originating from the computational resource 2-1 allocated to the network 3-1 for which the communication scheme is VLAN (communication A), a VLAN tag is added to the packet header, and the resulting packet is forwarded to the network 3-1. On the other hand, if the communication scheme allocated is the Ethernet, the control unit 12 sets a value of CRC (Cyclic Redundancy Check) in an FCS (Frame Check Sequence) field. This CRC value has been calculated from the fields of a destination address, a source address, a length/type and data. Note that such processing performed in case of using the Ethernet is needed not only when the communication scheme allocated is Ethernet but also when a virtual network is constructed over Ethernet using another communication scheme.

In the foregoing, such an instance where single applications are carried out one-by-one using the computational resources 2 has been shown. Alternatively, a plurality of applications, one in each of the computational resources 2, may be run simultaneously, with respective different communications then taking place by the running of the respective applications. In this case, the allocation unit 1 may allocate one and the same communication scheme or respective different communication schemes to the multiple applications booted using the computational resources 2.

It is also possible for the control unit 12 to take account not only of the policies of the policy DB 13 but also of the statuses of communications proceeding in the networks 3 in allocating the networks. For example, suppose that the communication scheme (1), capable of guaranteeing the bandwidth of 10 Gbps, is allocated to the user A. Even in such case, if the network 3-1 associated with the communication scheme (1) is congested, the communication scheme which is associated with a different value of the requested condition, such as the “bandwidth guarantee of 5 Gbps,” and which is associated e.g., with the network 3-3, may be allocated to the computational resource 2-1 destined for the user A.

It may be seen from above that the second exemplary embodiment provides for communication making use of a network of an optimum communication scheme in compliance with the user's requested condition.

### Third Exemplary Embodiment

A third exemplary embodiment of the present invention will now be described with reference to the drawings. With the subject third exemplary embodiment, the communication scheme, allocated to the computational resources, can be decided at variable timings by the allocation unit 1. Moreover, the communication scheme allocated to the computational resources can be changed at variable timings by the allocation unit 1. In the following, the timings for the allocation unit to decide on the communication schemes and to change the communication schemes are shown by giving respective examples.

### (Operations in Starting the Allocation of the Communication Scheme)

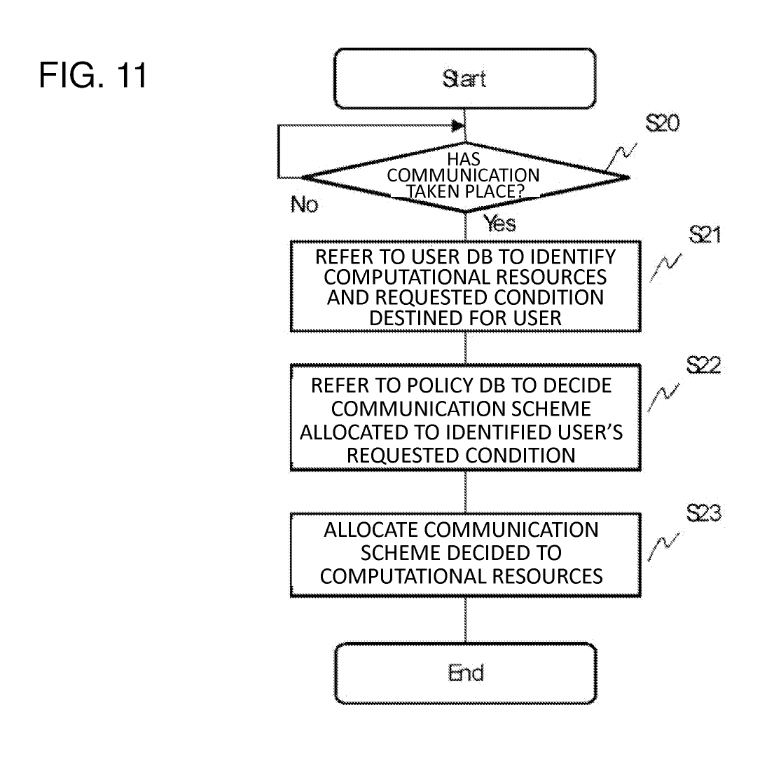

FIG. 11 depicts a flowchart showing a sequence of operations to be performed when the allocation unit 1 allocates the communication scheme to the computational resources 2 in case of occurrence of a communication exploiting the computational resources 2. In such case, the allocation unit 1 verifies whether or not a communication exploiting the computational resources 2 has occurred (step S20). By the way, the operations as from the step S21 are the same as those from the step S11 to S13 in FIG. 10 and hence are not here explained.

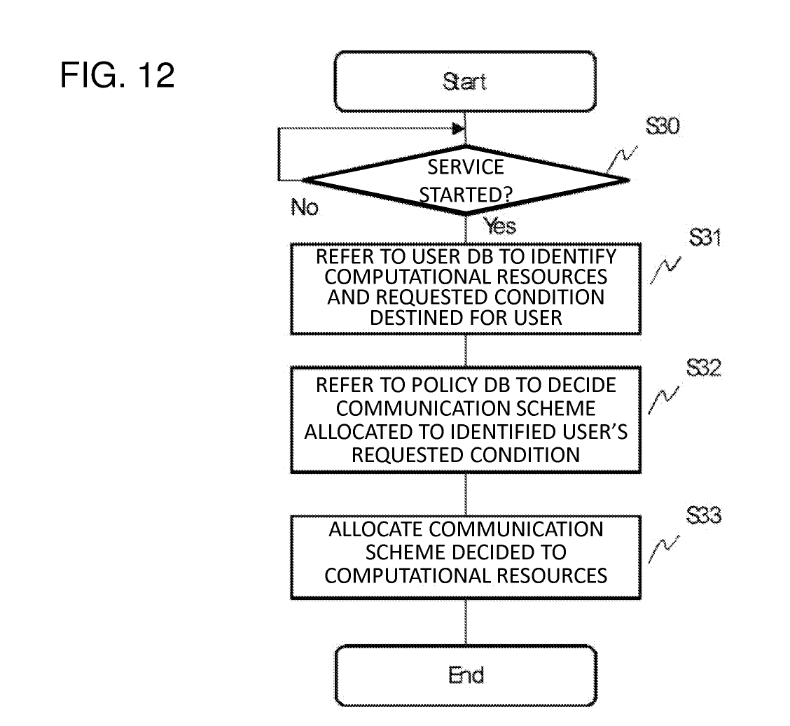

FIG. 12 depicts a flowchart showing a sequence of operations to be performed when a service exploiting computational resources 2 has been commenced and a communication scheme is to be allocated to the computational resources destined for a user exploiting the service. In this case, the allocation unit 1 verifies whether or not the service exploiting the computational resources 2 has been commenced (step S30). By the way, the operations as from the step S31 are the same as those from the steps S11 to S13 in FIG. 10 and hence are not here explained.

### (Operations in Changing the Communication Scheme Allocation)

An instance where the communication scheme allocated to the computational resources is to be changed will now be described.

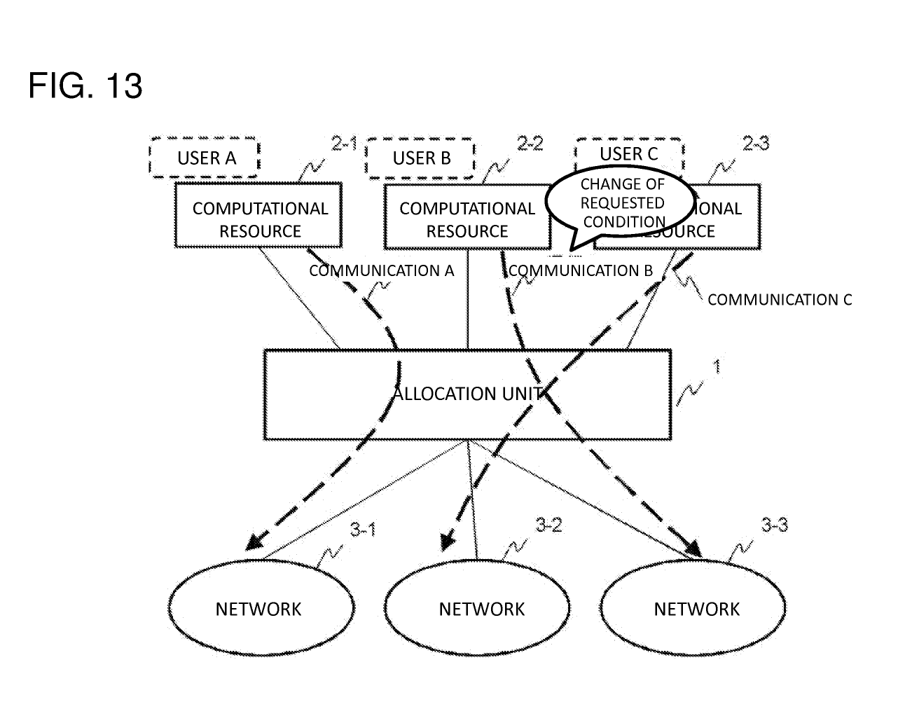

FIG. 13 shows an instance where, in case the user's requested condition has been changed, the allocation unit 1 changes the communication scheme allocated depending on the as-changed requested condition. In the instance of FIG. 13, it is assumed that a user B, having the communication scheme of the network 3-3 allocated, has upgraded the service, so that the communication bandwidth that can be guaranteed has been enhanced.

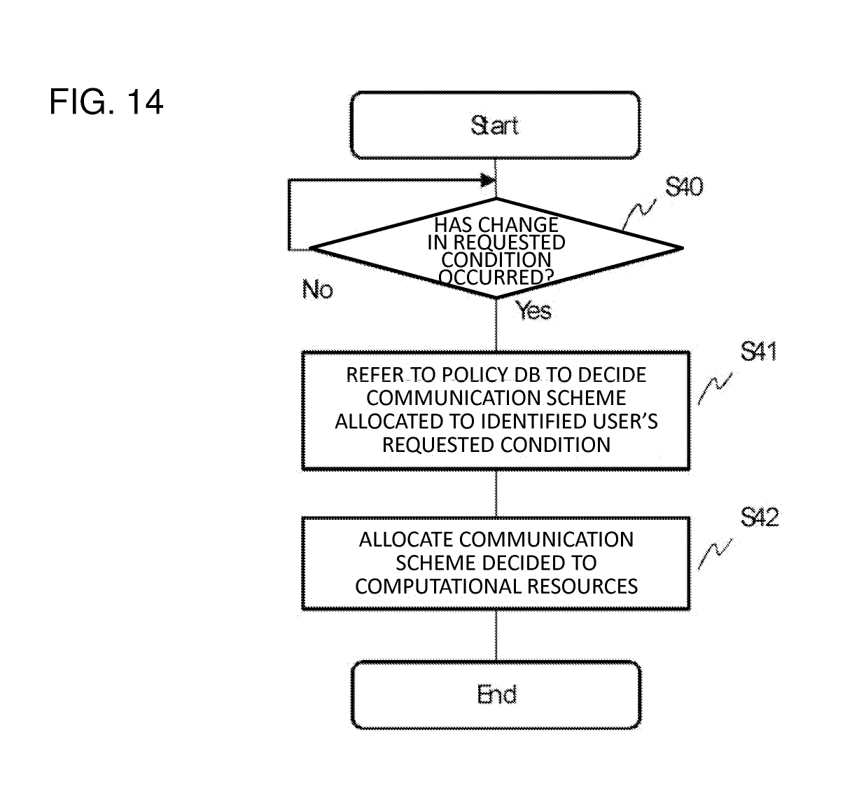

Referring to FIG. 14, the sequence of operations for such case will be explained.

The identification unit 11 monitors whether or not the requested condition of the user exploiting the computational resources 2 has been changed (step S40). For example, the identification unit 11 monitors the user DB 14 at a preset period.

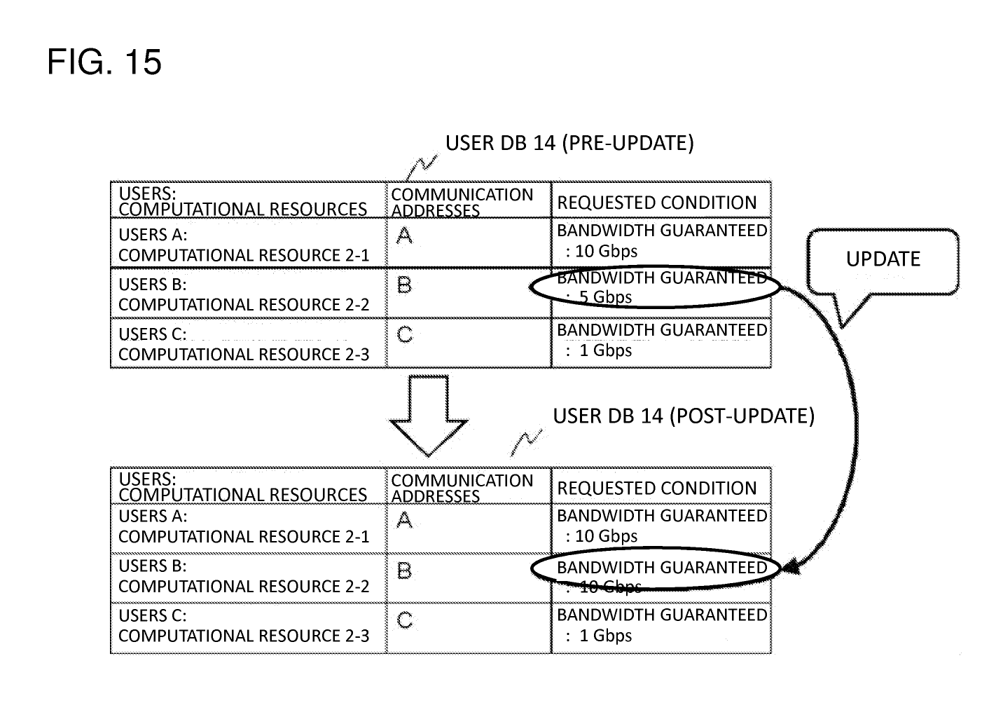

If, for example, the SLA has been changed by the user paying an additional fee, the user DB 14 is updated by a communication system operator. If, for example, the bandwidth guaranteed, which is the requested condition, is raised from “5 Gbps” to “10 Gbps” by the user paying the additional fee, as shown in FIG. 15, the user DB 14 is updated by the communication system operator. The identification unit 11 periodically monitors the user DB 14, as an example, so as to recognize the update of the requested condition for the user DB 14. The identification unit 11 may also recognize the update of the requested condition by a message sent from the computational resources 2 to the allocation unit 1.

The control unit 12 then references the policy DB 13 to decide on the communication scheme associated with the as-changed requested condition (step S41). The control unit 12 allocates the communication scheme, thus decided on, to the computational resources (step S42).

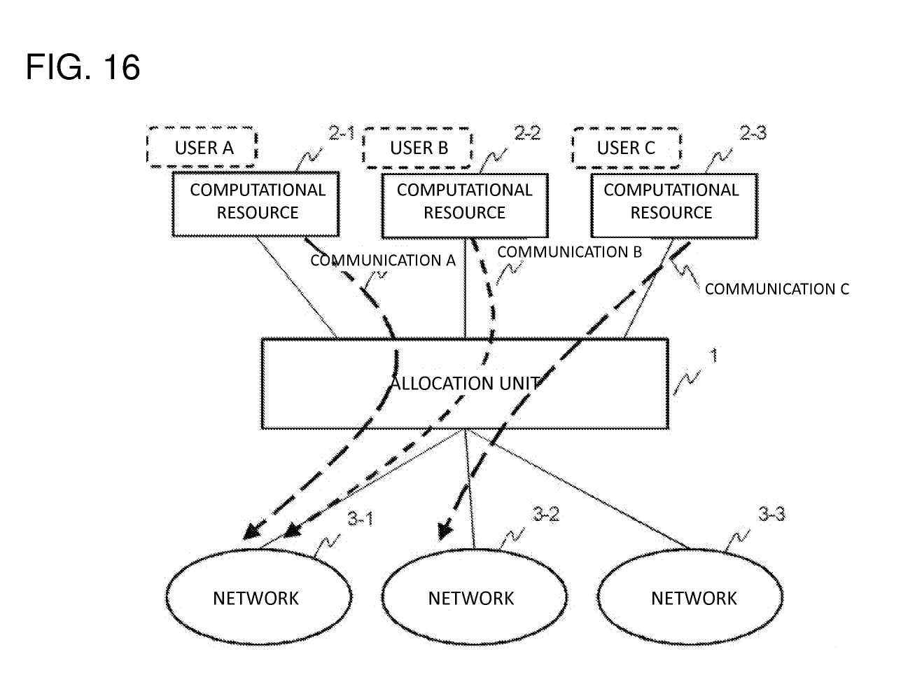

FIG. 16 shows the result of change of the communication scheme allocated to the computational resource 2-2 destined for the user B. In FIG. 16, the communication scheme allocated to the computational resource 2-2 destined for the user B is changed to a communication scheme associated with the as-changed requested condition (bandwidth guaranteed: 10 Gbps), viz., the communication scheme associated with the network 3-1.

### (Changing the Allocated Communication Scheme Depending on a Request for Changing)

An instance where the allocation unit 1 changes the allocation of the communication scheme to the computational resources depending on a request for changing the communication scheme from a system administrator or a user will now be explained.

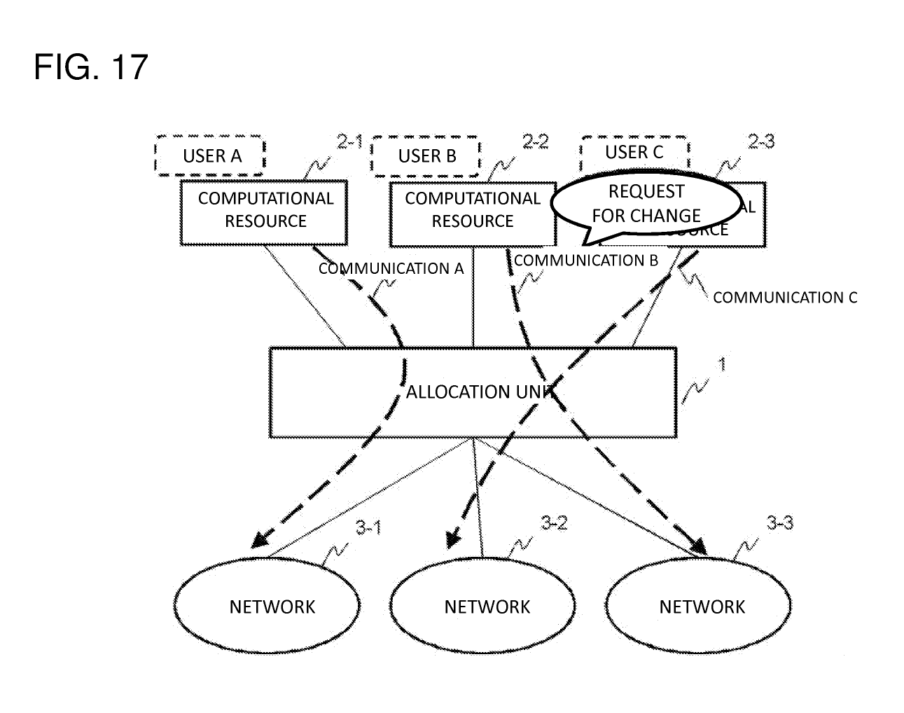

FIG. 17 shows an instance of a case where a request has been made for changing the communication scheme, allocated to the computational resource 2-2, destined for the user B, from a communication scheme associated with the network 3-3 to some other communication scheme. For example, it may be contemplated that an administrator, an operator etc. managing the system has to halt the operation at the network 3-3 due to maintenance or construction works, and a request is made from the administrator etc. to the allocation unit 1 for changing the communication scheme that is to be allocated to the computational resource 2-2 destined for the user B. As the case may be, a request for changing the communication scheme may be made from the user B in case he/she desires to change from the communication scheme currently allocated to a communication scheme associated with the faster network 3-1.

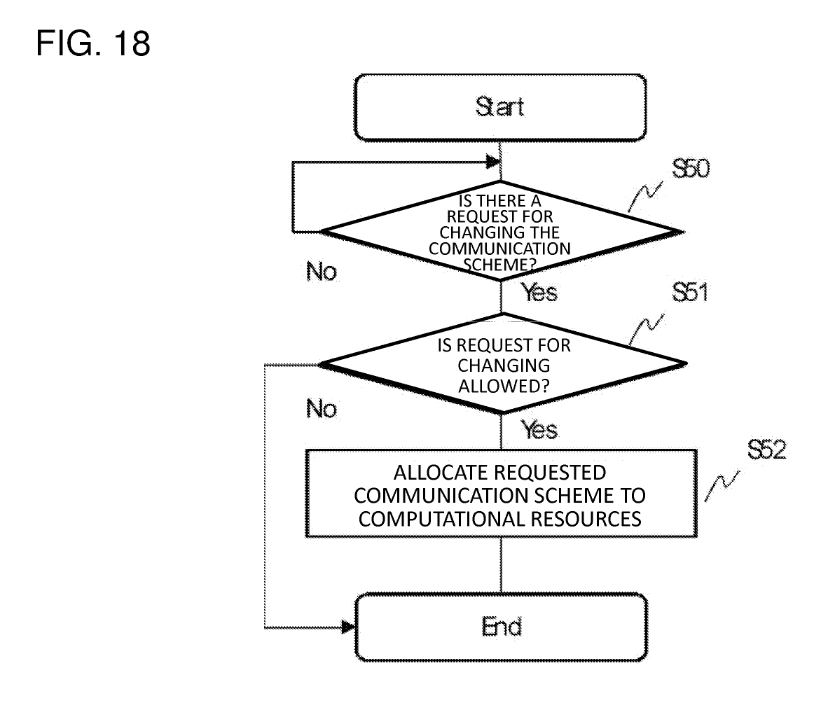

Referring to FIG. 18, the operation for such case will be explained. Initially, the identification unit 11 verifies whether or not a request for change has been made in connection with a given communication (step S50). The change request is made as a packet or a message from the computational resources 2 to the allocation unit 1. It is also possible for an administrator or an operator managing the system to send such change request to the allocation unit 1.

Next, if the change request has been made, the control unit 12 decides whether or not the change request may be allowed (step S51). If the change request is not allowed by the control unit 12, the operation is brought to a close (Yes of the step S51). Note that, in deciding whether or not the change request is allowed, a decision may be made by the control unit 12 in accordance with any suitable policy, or by a network operator. If a system administrator or operator requests the change, the step S51 may be dispensed with.

It is here assumed that a request has been made for changing the communication scheme allocated to the user B from the communication scheme associated with the network 3-3 to that associated with the network 3-1, as shown in FIG. 17. In such case, the control unit 12 allocates to the user B the communication scheme requested to be allocated (step S52).

By the way, if the change request has been allowed, it is possible for the control unit 12 to change the policies of the policy DB 13 in accordance with the content of the change request, although this is not shown in FIG. 18

With the third exemplary embodiment, described above, it is possible to start network allocation at variable timings or to dynamically change the allocated networks. This enables the system to be managed more flexibly.

### Fourth Exemplary Embodiment

In a fourth exemplary embodiment, an instance of applying the first to third exemplary embodiments to a centralized control system will be described.

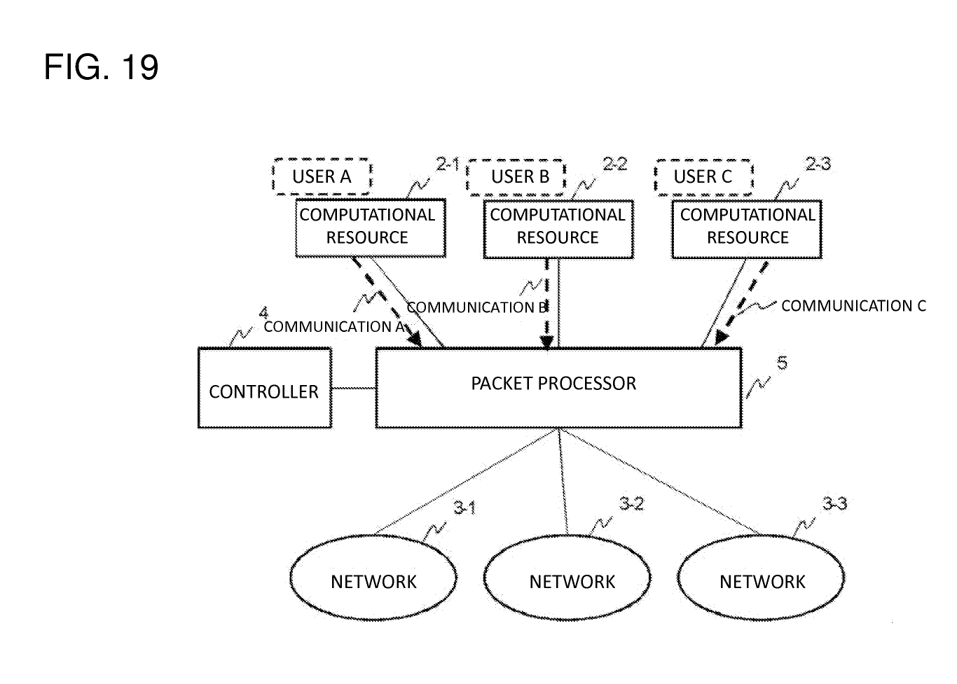

FIG. 19 shows an example configuration of the fourth exemplary embodiment. Referring to FIG. 19, the system of the fourth exemplary embodiment includes computational resources 2, a network 3, a controller 4 and a packet processor(s) 5. The computational resources 2 and the network 3 are the same as those of the first to third exemplary embodiments and hence are not explained in detail. Similarly to the allocation units 1 of the first to third exemplary embodiments, the packet processor(s) 5 allocates the communication schemes, associated with the respective networks 3, to the computational resources destined for the users. The packet processor(s) 5 differs from the allocation unit 1 in the packet processor being controlled by the controller 4.

Similarly to the allocation unit 1 in the first to third exemplary embodiments, the controller 4 decides on the communication schemes, allocated to the respective computational resources, by referencing a policy DB and a user DB, and notifies the packet processor of the communication scheme thus decided on.

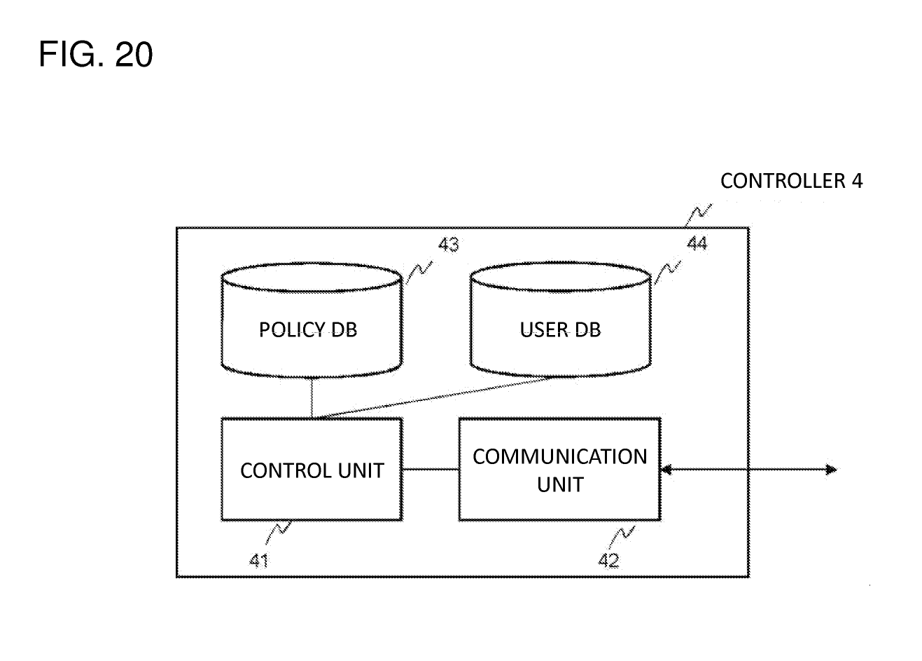

FIG. 20 shows an example configuration of the controller 4. The controller includes a control unit 41, a communication unit 42, a policy DB 43 and a user DB 44. The communication unit 42 is an interface configured for having communication with the packet processor(s) 5. The control unit 41 has functions that are approximately the same as those of the control unit 12 of the allocation unit 1 of the above described exemplary embodiment. In short, the control unit 41 decides, by referencing the policy DB 43 and the user DB 44, which communication scheme of which network is to be allocated to the computational resources associated with the communication mediated by the packet processor(s) 5.

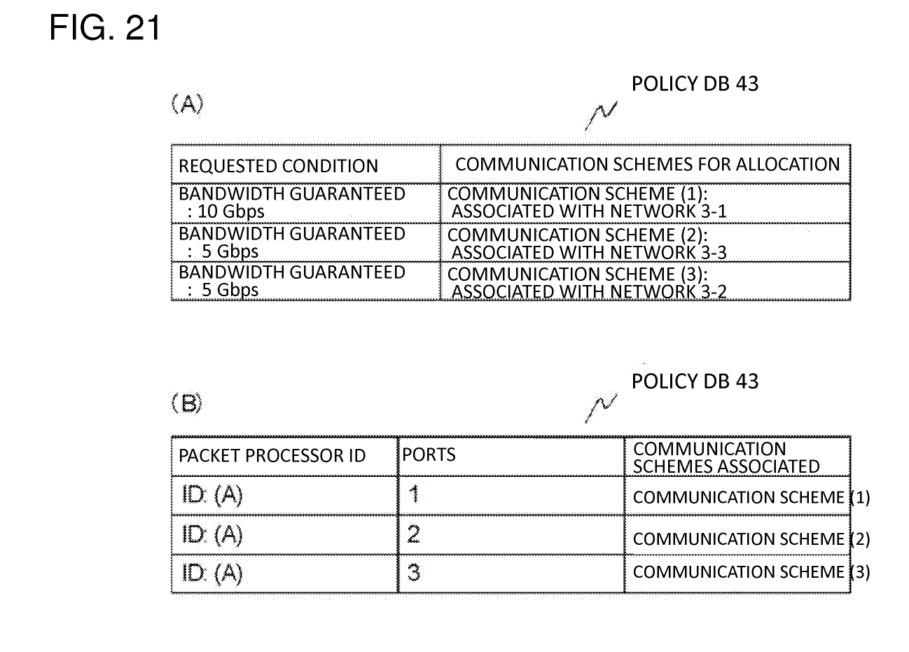

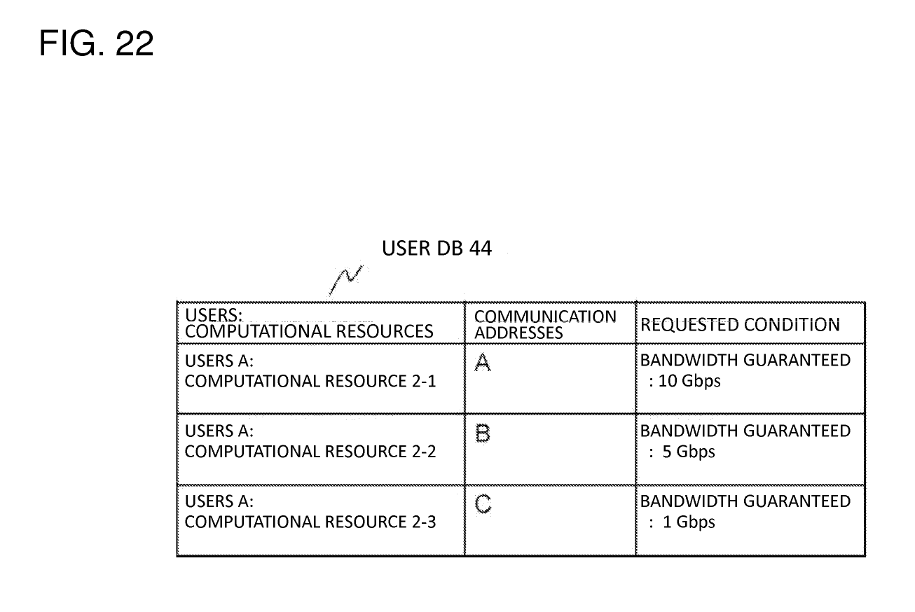

FIG. 21(A) and FIG. 21(B) show examples of the information stored in the policy DB 43. The policy DB 43 stores the communication schemes allocated depending on the requested condition, as shown for example in FIG. 21(A). The control unit 41 is able to allocate the communication schemes conforming to the user's requested condition by referring to FIG. 21(A) and to the user DB 44 shown in FIG. 22. The policy DB 43 may also store which communication schemes are associated with which ports of the packet processor(s), as shown in FIG. 21(B). The ports of the packet processor(s) are connected to respective networks 3. In short, the ports of the packet processor(s) are associated with the communication schemes of the networks 3 the ports are connected to. The policy DB 43, shown in FIG. 21(B), manages the relationship of correspondence between the ports and the communication schemes. More specifically, from one ID of the packet processor(s) to another, the ports of the packet processor carrying the IDs of the packet processor(s) are associated with the communication schemes. The control unit 41 is able to identify the port associated with the communication scheme allocated by referencing the information of FIG. 21B. The control unit 41 may reference the user DB 44 shown for example in FIG. 22 to notify the packet processor(s) 5 as to which port is associated with the communication address.

FIG. 22 shows examples of the information stored in the user DB 44. By the way, the user DB 44 is the same as those of the above mentioned first to third exemplary embodiments and hence is not explained in detail.

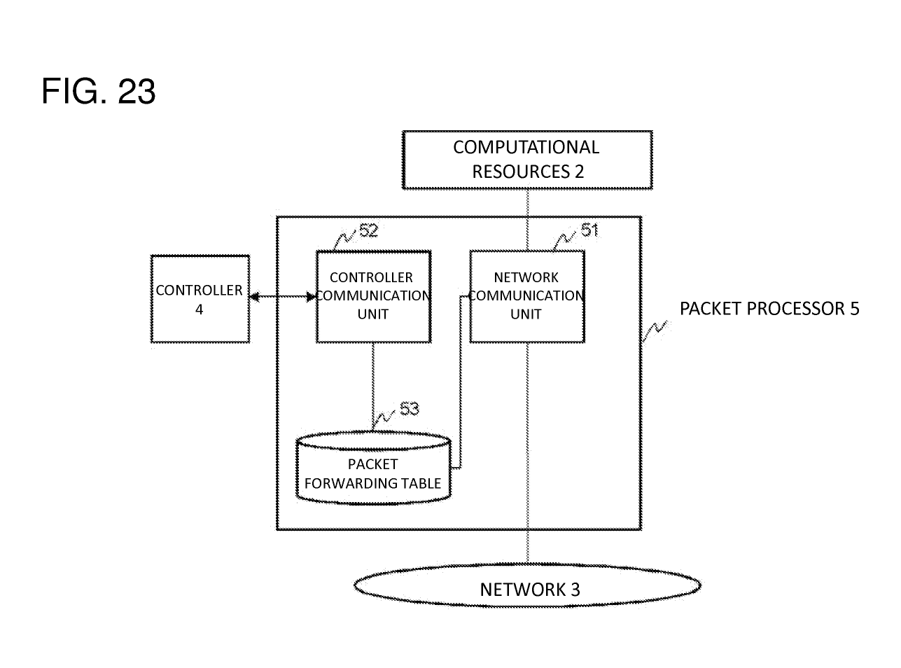

FIG. 23 depicts a block diagram showing an example configuration of the packet processor(s) 5, which packet processor(s) 5 includes a network communication unit 51, a controller communication unit 52 and a packet forwarding table 53.

The network communication unit 51 communicates with the computational resources 2 and the network 3 by referencing the packet forwarding table 53 which will be explained later in detail.

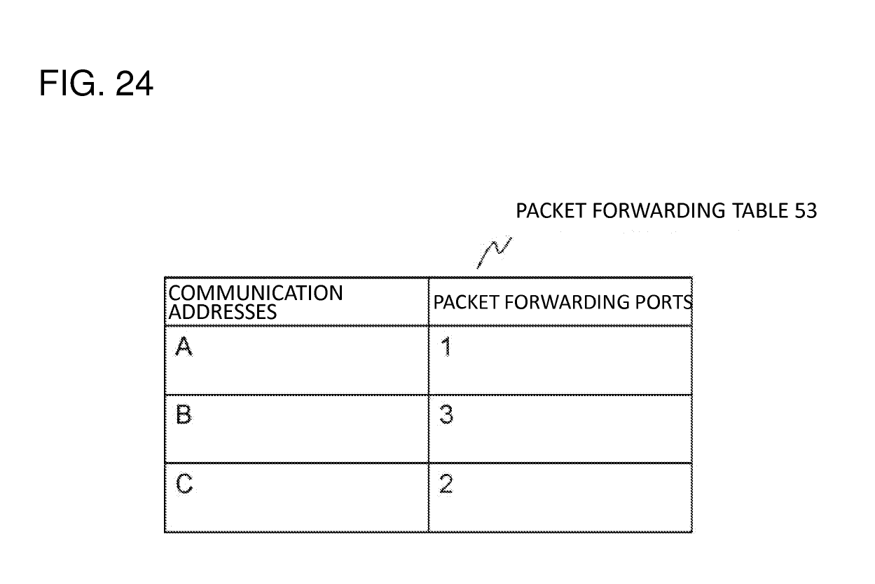

The controller communication unit 52 stores the information in the packet forwarding table 53 in accordance with a notification from the controller 4. In accordance with the allocation of the computational resources to the communication schemes decided, the controller informs the controller communication unit 52 about a packet forwarding port associated with the communication address associated in turn with the computational resources. The controller communication unit 52 stores the information, shown for example in FIG. 24, in the packet forwarding table 53. The packet forwarding table stores the communication addresses contained in the packets and the ports out which the packets are forwarded (packet forwarding ports).

The network communication unit 51 forwards the packets, received from the respective computational resources, out the ports associated with the communication schemes, allocated to the respective computational resources, in accordance with the packet forwarding table 53 shown for example in FIG. 24.

The packet forwarding table 53 stores the communication addresses, associated with the respective computational resources, and the port numbers associated with the communication schemes allocated to the respective computational resources. For example, the communication scheme, allocated to the computational resource 2-1, carrying the communication address “A,” is associated with the port number “1” of the packet processor(s) 5. In this case, the network communication unit 51 forwards the received packet, carrying the source address “A,” out the port “1” in accordance with the table shown for example in FIG. 24. By this operation of the network communication unit 51, the packets, sent from the respective computational resources, are forwarded to the networks associated with the communication schemes allocated to the respective computational resources.

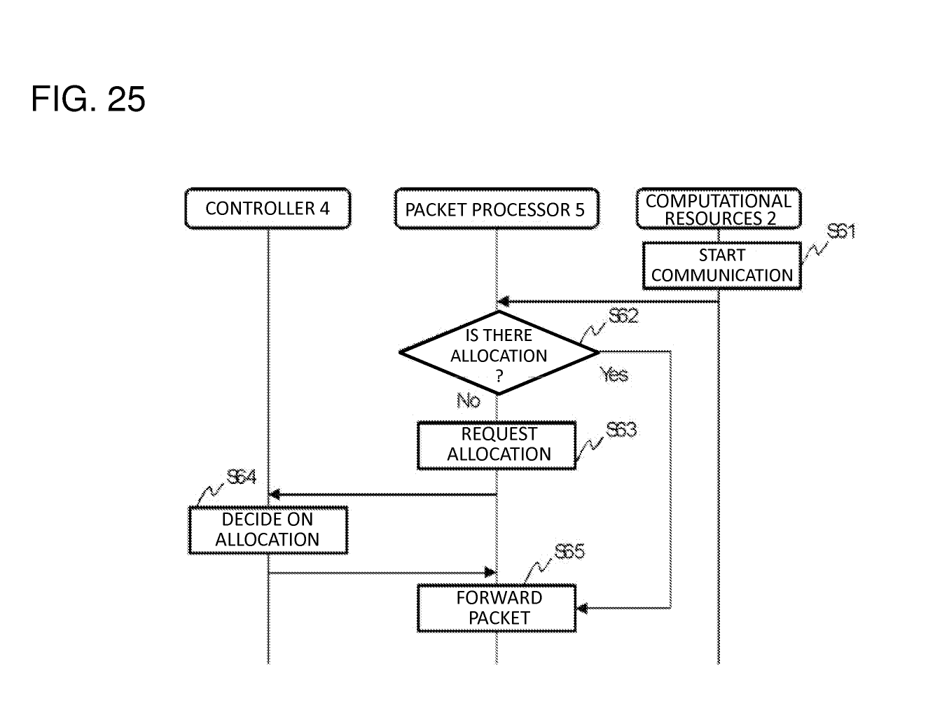

Referring to a sequence chart, shown in FIG. 25, the operation of the fourth exemplary embodiment will be explained.

The user commences communication using the computational resources 2 (step S61). Here, such a case where a communication A has taken place by the user A exploiting the computational resource 2-1 will be explained. Note that the communication address of the computational resource 2-1 is “A,” as in the other exemplary embodiments.

The network communication unit 51 of the packet processor(s) 5 identifies the communication address contained in the packet of the communication A received. In the above instance, the network communication unit 51 finds that the communication address contained in the packet of the communication A received is A.

The network communication unit 51 references the packet forwarding table 53 to decide whether or not a packet forwarding port has been allocated to the communication address A (step S62). For example, the network communication unit 51 decides if the packet forwarding port has been allocated to the communication address A, depending on whether or not an entry associated with the communication address A resides in the packet forwarding table 53.

If it is found in the step S62 that no packet forwarding port has been allocated to the communication address A, the controller communication unit 52 sends to the controller 4 a request for allocating the packet forwarding port to the communication address “A” (step S63).

On receipt of this allocation request, the control unit 41 of the controller 4 references the policy DB 43 and the user DB 44 to decide that the communication scheme associated with the network 3-1 will be allocated to the computational resource 2-1 associated with the communication address A (step S64). The operation of allocation by the control unit 41 is carried out in substantially the same way as that by the control unit 12 of the identification unit 1, described above, and hence is not explained in detail. In case the control unit 41 has decided on allocating the communication scheme of the network 3-1 to the computational resource 2-1, the control unit sends a notification to the packet processor(s) 5 that the packet forwarding port associated with the communication address A is “1.”

The packet processor(s) 5 updates the packet forwarding table 53 in accordance with the notification from the control unit 41. The network communication unit 51 references the packet forwarding table 53 and forwards the packet, sent from the computational resource 2-1, out the port 1 associated with the network 3-1 (step S65).

If it is found in the step S62 that the packet forwarding port has already been allocated to the communication address A, the network communication unit 51 references the packet forwarding table 53 and accordingly forwards the packet (No of the step S62).

In the above instance, the operation for a case the user has commenced communication has been stated. It is however also possible to optionally change the allocation of the communication schemes, as explained in connection with the third exemplary embodiment.

Moreover, even in the absence of the request from the packet processor(s) 5, it is possible for the controller 4 to decide the allocation of the communication scheme to the computational resources to set the communication address A associated with the packet forwarding port in the packet processor(s) 5. In this case, the above mentioned steps S61 to S63 are not carried out, with the controller 4 deciding the allocation of the communication schemes to the computational resources and setting the result in the packet processor(s) 5. It is also possible in this case for an administrator or operator managing the controller 4 to take the status of the user or the network into account so as to set the allocation of the communication scheme in the packet processor(s) 5 as appropriate.

### Advantageous Effect:

The fourth exemplary embodiment, described above, shows an instance of controlling the packet processor(s) 5 by the controller 4. By using a centralized controlling architecture, it is possible to exercise flexible control, using the controller, even if there are a larger number of packet processors 5.

### Fifth Exemplary Embodiment

A fifth exemplary embodiment of the present invention will now be described. With the subject fifth exemplary embodiment, the fourth exemplary embodiment is run using a technique known as OpenFlow of the centralized controlling architecture. Since the basic configuration is approximately the same as that of the fourth exemplary embodiment, the description of the configuration or operation similar to that of the previous exemplary embodiments is dispensed with.

The OpenFlow recognizes communication as an end-to-end flow and executes path control, recovery from malfunctions or load balancing on the flow-by-flow basis. By the flow is meant a series of communication packets having a preset property, as an example.

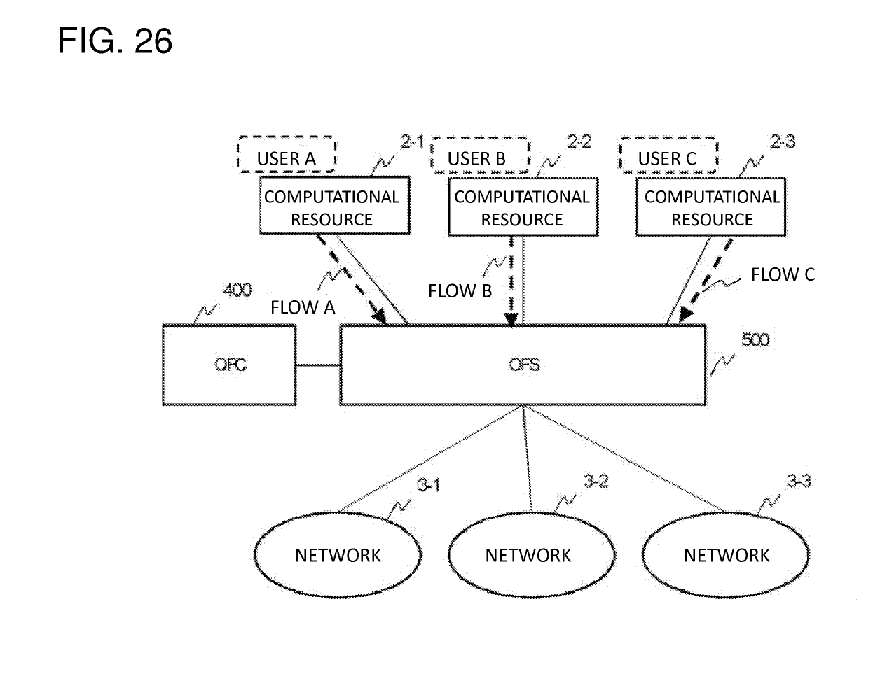

FIG. 26 shows an example configuration of a communication system according to the fifth exemplary embodiment. When the OpenFlow is applied, the controller 4 is running as an OpenFlow Controller 400, referred to below as OFC 400, and the packet processor 5 as an OpenFlow Switch 500, referred to below as an OFS 500. Note that the OFS 500 is e.g., a network switch constructed using the OpenFlow technique, the OFC 400 is an information processing unit controlling the OFS 500. It is assumed that the communication belonging to a flow A is carried out from the computational resource 2-1 exploited by the user A. Likewise, the communication belonging to a flow B is carried out from the computational resource 2-2 exploited by the user B and the communication belonging to a flow C from the computational resource 2-3 exploited by the user C.

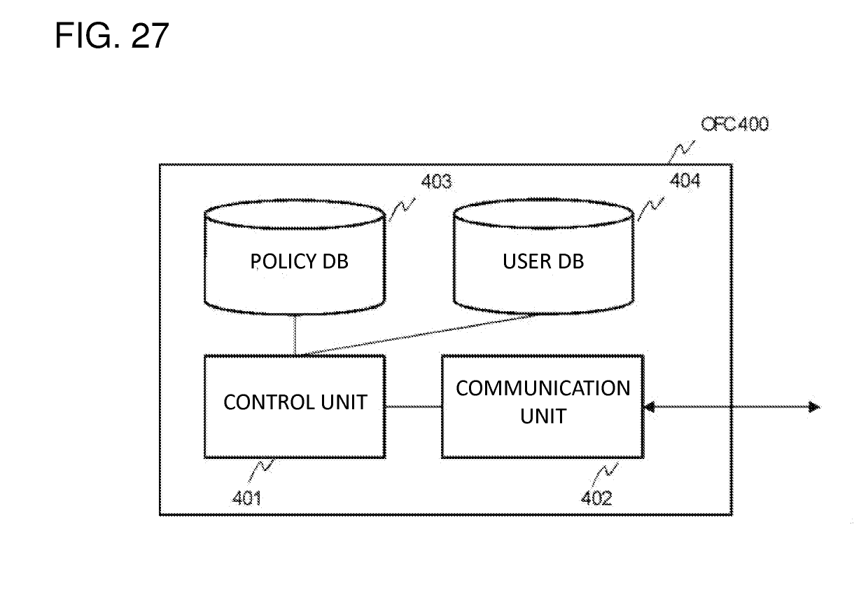

FIG. 27 depicts a block diagram showing an example configuration of the OFC 400, which OFC includes a control unit 401, a communication unit 402, a policy DB 403 and a user DB 404. The above configuration is substantially similar to the configuration of the controller 4 in the fourth exemplary embodiment and hence is not described in detail.

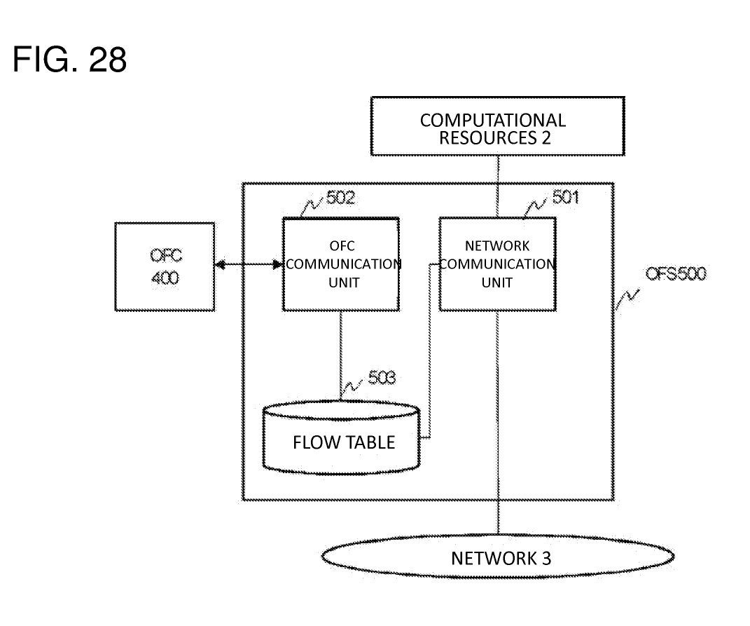

FIG. 28 shows an example configuration of the OFS 500, which OFS includes a network communication unit 501, an OFC communication unit 502 and a flow table 503.

The network communication unit 501 is connected to the computational resources 2 and the network 3 and refers to the flow table 503, later described in detail, so as to perform a processing concerning a packet received.

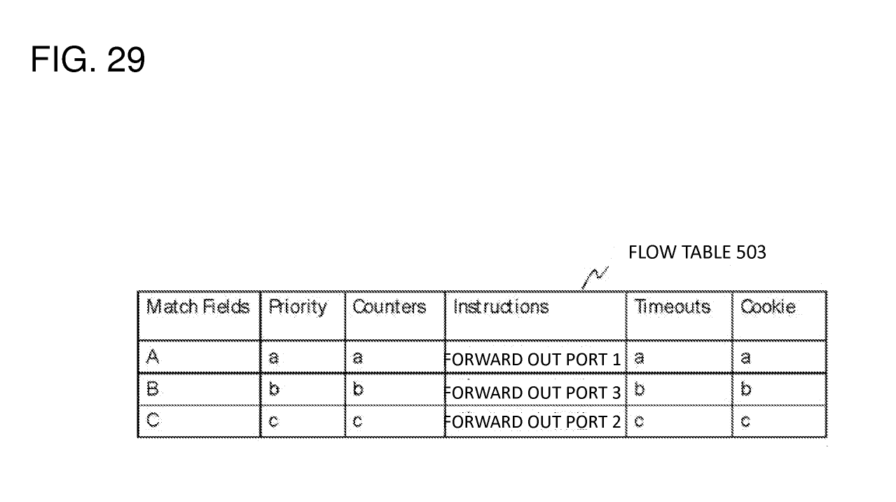

The OFC communication unit 502 stores the information in the flow table 503 in accordance with a notification from the OFC 400. The OFC 400 informs the OFC communication unit 502 about the information shown for example in FIG. 29 in accordance with the decided allocation of the computational resources and the communication schemes to each other. Detailed explanation on FIG. 29 will be made subsequently. The OFC communication unit 502 stores the information, shown for example in FIG. 29, in the flow table 503.

FIG. 29 shows an example configuration of each of entries (flow entries) of the flow table 503. Each flow entry includes a field (Match Field) for collation against the information of a packet received by the OFS 500, such as a destination IP address or VLAN ID, and a field (Instructions) including a method for processing a packet matching the matching rules (Action). The flow entry may contain a field (Priority) showing the priority level of the flow entry and a field (Counters) showing the packet flow based statistics information. The flow entry may also contain a field (Timeouts) showing the term of liveness of a flow entry (time) or the time until timeout and a field (Cookie) that may be optionally set by the OFC 400. Typically, one flow entry corresponds to one flow. However, by wildcarding a fraction of the Match Field, such as a destination IP address, a plurality of flows can be handled by a single flow entry.

The content of the flow table 503 will now be described more specifically. It is now assumed that, in an instance of FIG. 29, the entry of the flow table 503 with the match field of the flow table 503 being “A” corresponds to the flow sent from the user A, viz., from the computational resource 2-1. In the instance of FIG. 29, the Match Filed is indicated by “A” for simplicity. However, in effect, the flow is defined by a set of variable header information sorts including a source IP address, a destination IP address, a source MAC address, a destination MAC address and VLAN ID. For example, it is assumed that an entry with the match field “A” denotes that the source address of a packet is a communication address of computational resources destined for the user A. Likewise, it is assumed that an entry with the match field of “B” corresponds to the flow from the user B and an entry with the Match Field of “C” to the flow from the user C. The Instructions of the flow from the user A state the processing method to “forward out the port 1.” This shows the processing content that the OFS 500 forwards a packet with the match field “A” out the port 1. As an example, providing that the communication scheme, allocated to the computational resources, destined for the user A, is associated with the port 1, the OFS 500 is able to forward the packet to the network of the communication scheme allocated to the computational resources, destined for the user A, by the processing method to “forward out the port 1.” Other processing contents stated in the “Instructions” include “forwarding a received packet out a provided port,” “dropping a received packet” and “modifying part of the header of a received packet and forwarding the packet out a provided port.”

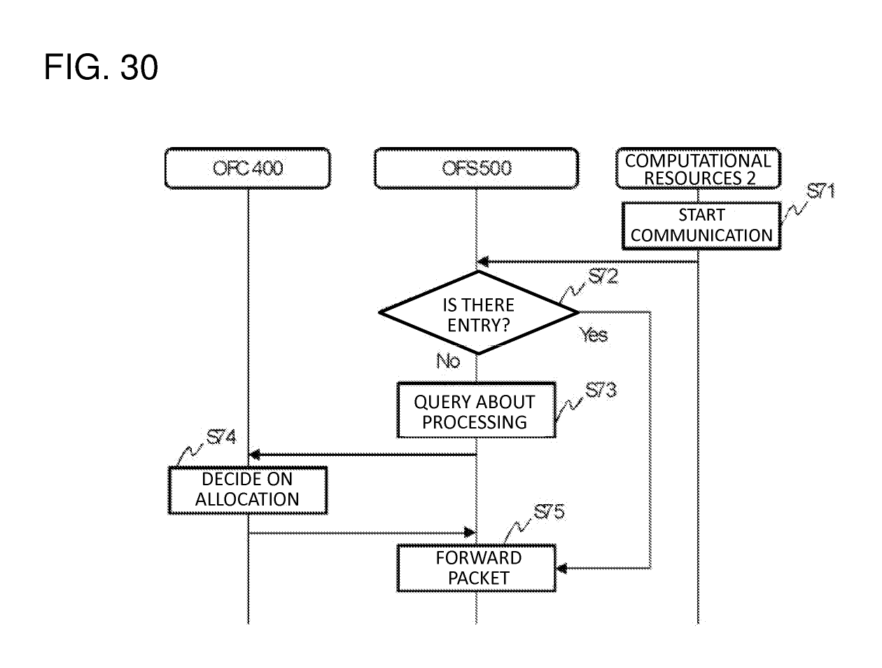

Referring to a sequence chart of FIG. 30, the operation of the fifth exemplary embodiment will be explained. Initially, a user commences communication using the computational resources 2 (step S71). Here, a case where a user A has commenced communication by a flow A using the computational resource 2-1 is explained.

Next, the network communication unit 501 of the OFS 500 refers to the flow table 53 in connection with a packet of the flow A received, and searches for a flow entry matching the header information of the received packet (step S72). If, for example, the match field associated with the flow A is “A,” the network communication unit 501 searches the flow table 503 as to whether or not there is an entry having the match field A.

If, in the step S72, there is no flow entry matching the flow A, the OFC communication unit 502 queries the OFC 400 about the processing to be performed on the flow A (step S73).

On receipt of this query, the control unit 401 of the OFC 400 refers to the policy DB 403 and the user DB 404 to decide in a step S74 that the communication scheme associated with the network 3-1 will be allocated to the computational resources of the user A (flow A). Since the operation concerning the allocation by the control unit 401 is substantially the same as that performed by the control unit 41 of the fourth exemplary embodiment, any detailed description therefor is dispensed with. The control unit 401 then sets the flow entry concerning the allocation of the communication scheme decided on. In short, the control unit 401 makes setting for the OFS 500 for forwarding the packet for the flow A out the port associated with the network 3-1. In this manner, the OFC 400 is able to set allocating the network 3-1 to the user A in the OFS 500.

The OFS 500 updates the flow table 503 in accordance with the setting from the OFC 400. In the above instance, a processing method stipulating forwarding a packet out the port 1 associated with the network 3-1 is set in the flow entry whose match field associated with the flow A is A, as shown in FIG. 29. The OFS 500 forwards the received packet out the port 1 in accordance with the updated flow table 503 (step S75).

If the flow entry associated with the flow A is found in the step S72, the OFS 500 forwards the received packet out the port 1 without querying the OFC 400 about the processing content (No in the step S72).

In the above instance, the operation when the user has commenced the communication has been stated. It is however also possible to change the allocation of the communication schemes, as appropriate, as stated in connection with the third exemplary embodiment.

Moreover, even if no request is made from the OFS 500, it is possible for the OFC 400 to decide the allocation of the communication schemes to the computational resources so as to set the corresponding flow entry for the OFS 500. In this case, it is possible for the OFC 400 to decide the allocation of the communication schemes to the communication resources, with omission of the above mentioned steps S71 to S73, and to set a flow entry in keeping with the so decided communication scheme allocation in the OFS 500. It is also possible for the administrator or the operator managing the OFC 400 to set the flow entry in keeping with the network allocation in the OFS 500 as the status of the user or that of the network is taken into account.

An instance of application in case of using the OpenFlow has been shown above. It is however also possible to apply a technique other than OpenFlow as long as the system used has the centralized control architecture.

### Advantageous Effect:

The fifth exemplary embodiment, described above, is directed to such a case where the OpenFlow is applied to the fourth exemplary embodiment to control the OFC 500 by the OFC 400. Since the centralized control architecture is used as in the fourth exemplary embodiment, flexible control may be exercised by using the OFC 400 even though there are larger numbers of the OFSs 500.

### Sixth Exemplary Embodiment

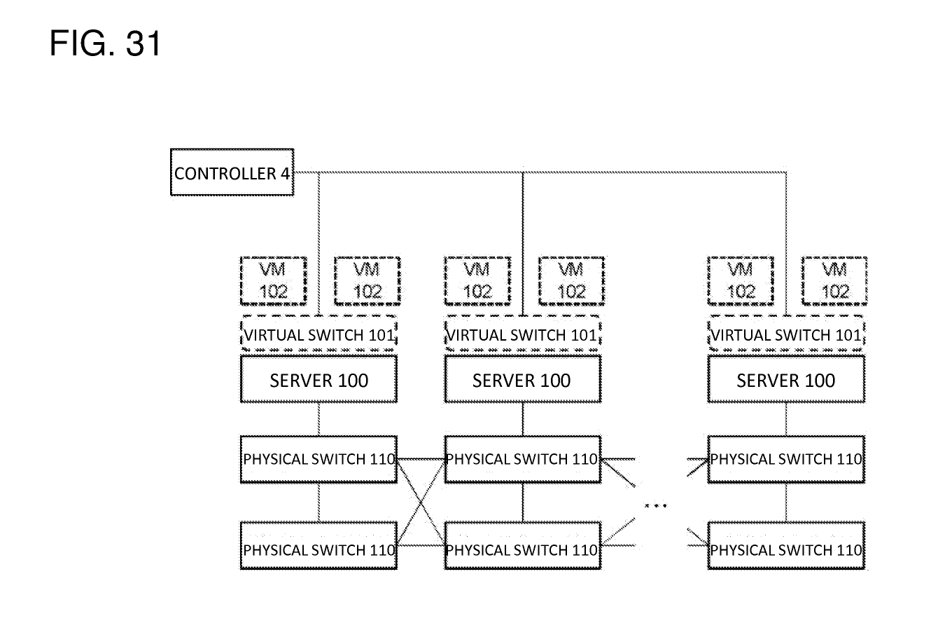

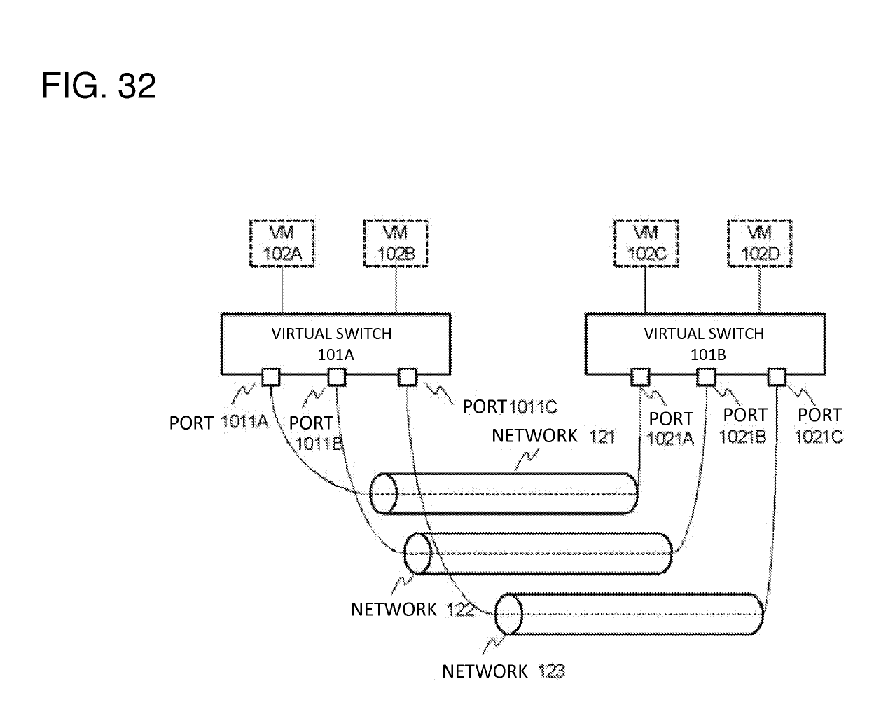

A sixth exemplary embodiment will now be explained with reference to FIG. 31 and FIG. 32.

In a system of the sixth exemplary embodiment, there are provided a controller 4, a set of virtual switches (vSwitches) 101, a set of servers 100, a set of physical switches 110 and a set of virtual machines (VMs) 102, as shown in FIG. 31.

Each virtual switch 101 is a network switch constructed by software running on the server 100. The virtual switch 101 has functions corresponding to those of the packet processor 5 of the fourth exemplary embodiment or the OFS 500 of the fifth exemplary embodiment. In short, the virtual switch 101 processes a packet under control by the controller 4. By the way, the virtual switch 101 is located at an end point (edge) of a network made up by the physical switches 110.

In the server 100, the virtual machines (VMs), which are computers constructed by software, are in operation. The VMs 102 communicate with one another via the virtual switches 101.

The functions of the VMs 102 correspond to those of the computational resources 2 of the previous exemplary embodiments. The VMs 102 communicate with one another via a network of the physical switches 110 (underlay network) or via a virtual network (overlay network) constructed over the physical switches 110. The network (underlay network) is constructed on the basis of a communication scheme exemplified by IPv4 or IPv6, as discussed above. The virtual network is constructed on the basis of communication schemes exemplified by VLAN, L2TP, Ethernet IP, GRE, NVGRE or IPsec, also as discussed above. These networks correspond to the networks 3 of the previous exemplary embodiments.

The controller 4 has the functions corresponding to those of the controller 4 of the fourth exemplary embodiment or the OFC 400 of the fifth exemplary embodiment. That is, the controller 4 decides which communication scheme is to be allocated to the communication originating from the VM 102.

The virtual switch 101 processes a packet in accordance with the processing rules notified from the controller 4.

The servers 100 are located at one end (edge) of the network constructed by the physical switches 110. In this case, the controller 4 controls the operation of the virtual switches 101 located at an edge of the network.

Referring to FIG. 32, an instance of communication operations among the VMs 102 will be explained. The instance of FIG. 32 is such a one where VMs 102A, 102B communicate with VMs 102C, 102D over virtual switches 101A, 101B.

The virtual switch 101A includes ports 1011A, 1011B and 1011C, and likewise the virtual switch 101B includes ports 1021A, 1021B and 1021C. In the instance of FIG. 32, the ports are connected to networks of different communication schemes. Specifically, the port 1011A is connected to the network 121, and the port 1011B to a network 122. The port 1011C is connected to a network 123. The networks 121 to 123 may be constructed on the basis of respective different communication schemes, as discussed above.

The virtual switch 101A performs operations similar to those of the packet processor 5 of the fourth exemplary embodiment or the OFS 500 of the fifth exemplary embodiment, so as to allocate the communication schemes associated with the values of the requested condition of the VMs 102A, 102B to the VMs 102A, 102B, respectively. For example, it is assumed that the requested condition associated with the VM 102A is such a one that guarantees a bandwidth of 10 Gbps, and that the network 121 is such a one constructed on the basis of the communication scheme that satisfies the condition of guaranteeing the bandwidth of 10 Gbps. In such case, the communication scheme satisfying the condition of guaranteeing the bandwidth of 10 Gbps is allocated to the VM 102A. In the above case, the network associated with the communication scheme satisfying the condition of guaranteeing the bandwidth of 10 Gbps is the network 121. Hence, the communication originating from the VM 102A is carried out via a port 1016A connected to the network 121.

After allocation of the communication schemes to the VMs 102, communication is carried out by operations conforming to the respective communication schemes. For example, if the communication scheme of the network 121 is VLAN, the virtual switch 101A adds a VLAN tag to a header of a packet originating from the VM 102A allocated to the network 121, and forwards the so tagged packet to the network 121.

The controller 4 informs the virtual switch 101A about the processing rules stipulating adding the VLAN tag associated with the network 121 to the packet originating from the VM 102A. On receipt of the packet, originating from the VM 102A, as an example, the virtual switch 101A adds the VLAN tag associated with the network 121 to the packet in accordance with the instructions of the controller 4 and accordingly forwards the packet.

### Advantageous Effect:

By the controller 4 controlling just the virtual switch 101A, as in the sixth exemplary embodiment, it is possible to suppress load on the controller 4. It is also possible to introduce a centralized controlling network by the controller 4 without supplanting pre-existing equipment of the communication system, such as physical switches 110.

Although the present invention has been described above with reference to the preferred exemplary embodiments, the present invention is not to be restricted to the above described exemplary embodiments. A variety of modifications that may be understood by those skilled in the art within the scope of the present invention may be made to the configuration or specifics of the present invention.

### (Mode 1)

A communication system, comprising:

a computational resource(s) allocated to a user; and

allocation means that allocates at least one of a plurality of communication schemes to the computational resource(s) based on a requested condition concerning a service rendered to the user via the computational resource(s).

### (Mode 2)

The communication system according to mode 1, wherein

the allocation means allocates to the computational resources a communication scheme out of the plurality of communication schemes that satisfies the requested condition.

### (Mode 3)

The communication system according to mode 1 or 2, wherein

a network(s), associated with the plurality of communication schemes, comprises a first network and a second network; the second network having to perform, in addition to processing needed in communication making use of the first network, a packet processing conforming to a communication scheme associated, and

the allocation means allocates a communication scheme associated with the first network to the computational resource(s) in case the communication scheme associated with the second network fails to satisfy the requested condition.

### (Mode 4)

The communication system according to any one of modes 1 to 3, wherein

a network(s), associated with the plurality of communication schemes, comprises a physical network and a virtual network constructed over the physical network, and

the allocation means allocates a communication scheme associated with the virtual network to the computational resource(s) in case a communication scheme associated with the physical network fails to satisfy the requested condition.

### (Mode 5)

The communication system according to any one of modes 1 to 4, wherein

the allocation means allocates at least one of the plurality of communication schemes to the computational resource(s) depending on the requested condition and on a communication status of a network(s) associated with the plurality of communication schemes.

### (Mode 6)

The communication system according to any one of modes 1 to 5, wherein

the allocation means allocates at least one of the plurality of communication schemes to the computational resource(s) in response to occurrence of communication related to the computational resource(s).

### (Mode 7)

The communication system according to any one of modes 1 to 6, wherein

the allocation means allocates at least one of the plurality of communication schemes to the computational resource(s) in response to start of the service.

### (Mode 8)

The communication system according to any one of modes 1 to 7, wherein

the allocation means changes allocation of a communication scheme in response to change of the requested condition corresponding to the user.

### (Mode 9)

The communication system according to any one of modes 1 to 8, wherein

the allocation means changes allocation of a communication scheme in response to a request for changing the allocated communication scheme.

### (Mode 10)

The communication system according to any one of modes 1 to 9, comprising:

a controller that decides a communication scheme to be allocated to the computational resource(s) and that issues a notification to the allocation means about the decided communication scheme, wherein

the allocation means allocates at least one of the plurality of communication schemes to the computational resource(s) in accordance with the notification.

### (Mode 11)

A node, comprising:

allocation means that, based on a requested condition concerning a service rendered to a user via a computational resource(s) allocated to the user, allocates at least one of a plurality of communication schemes to the computational resource(s).

### (Mode 12)

The node according to mode 11, wherein

the allocation means allocates to the computational resources a communication scheme out of the plurality of communication schemes that satisfies the requested condition.

### (Mode 13)

The node according to mode 11 or 12, wherein

a network(s), associated with the plurality of communication schemes, comprises a first network and a second network; the second network having to perform, in addition to processing needed in communication making use of the first network, a packet processing conforming to a communication scheme associated, and

the allocation means allocates a communication scheme associated with the first network to the computational resources in case the communication scheme associated with the second network fails to satisfy the requested condition.

### (Mode 14)

The node according to any one of modes 11 to 13, wherein

a network(s), associated with the plurality of communication schemes, comprises a physical network and a virtual network constructed over the physical network, and

the allocation means allocates a communication scheme associated with the physical network to the computational resource(s) in case a communication scheme associated with the virtual network fails to satisfy the requested condition.

### (Mode 15)

node according to any one of modes 11 to 14, wherein

allocation means allocates at least one of the plurality of communication schemes to the computational resource(s) depending on the requested condition and on a communication status of a network(s) associated with the plurality of communication schemes.

### (Mode 16)

The node according to any one of modes 11 to 15, wherein

the allocation means allocates at least one of the plurality of communication schemes to the computational resource(s) in response to occurrence of communication related to the computational resource(s).

### (Mode 17)

The node according to any one of modes 11 to 16, wherein

the allocation means allocates at least one of the plurality of communication schemes to the computational resource(s) in response to start of the service.

### (Mode 18)

The node according to any one of modes 11 to 17, wherein

the allocation means changes allocation of a communication scheme in response to change of the requested condition corresponding to the user.

### (Mode 19)

The node according to any one of modes 11 to 18, wherein

the allocation means changes allocation of a communication scheme in response to a request for changing the allocated communication scheme.

### (Mode 20)

A controller, comprising:

allocation means that allocates at least one of a plurality of communication schemes to a computational resource(s), allocated to a user, based on a requested condition concerning a service rendered to the user via the computational resource(s); and

communication means that informs a node connected to the computational resource(s) about the allocated communication scheme.

### (Mode 21)

The controller according to mode 20, wherein

the allocation means allocates to the computational resources a communication scheme out of the plurality of communication schemes that satisfies the requested condition.

### (Mode 22)

The controller according to mode 20 or 21, wherein

a network(s), associated with the plurality of communication schemes, comprises a first network and a second network; the second network having to perform, in addition to processing needed in communication making use of the first network, a packet processing conforming to a communication scheme associated, and

the allocation means allocates a communication scheme associated with the first network to the computational resource(s) in case the communication scheme associated with the second network fails to satisfy the requested condition.

### (Mode 23)

The controller according to any one of modes 20 to 22, wherein

a network(s), associated with the plurality of communication schemes, comprises a physical network and a virtual network constructed over the physical network, and

the allocation means allocates a communication scheme associated with the physical network to the computational resource(s) in case a communication scheme associated with the virtual network fails to satisfy the requested condition.

### (Mode 24)

The controller according to any one of modes 20 to 23, wherein

the allocation means allocates at least one of the plurality of communication schemes to the computational resource(s) depending on the requested condition and on a communication status of a network(s) associated with the plurality of communication schemes.

### (Mode 25)

The controller according to any one of modes 20to 24, wherein

the allocation means allocates at least one of the plurality of communication schemes to the computational resource(s) in response to occurrence of communication related to the computational resource(s).

### (Mode 26)

The controller according to any one of modes 20 to 25, wherein

the allocation means allocates at least one of the plurality of communication schemes to the computational resource(s) in response to start of the service.

### (Mode 27)

The controller according to any one of modes 20 to 26, wherein

the allocation means changes allocation of a communication scheme in response to change of the requested condition corresponding to the user.

### (Mode 28)

The controller according to any one of modes 20 to 27, wherein

the allocation means changes allocation of a communication scheme in response to a request for changing the allocated communication scheme.

### (Mode 29)

A communication method, comprising:

based on a requested condition concerning a service rendered to a user via a computational resource(s) allocated to the user, allocating at least one of a plurality of communication schemes to the computational resource(s).

### (Mode 30)

A communication method, comprising:

allocating at least one of a plurality of communication schemes to a computational resource(s) allocated to a user based on a requested condition concerning a service rendered to the user via the computational resource(s); and

informing a node connected to the computational resource(s) about the allocated communication scheme.

### (Mode 31)

A program causing a node, connected to a computational resource(s) allocated to a user, to execute:

based on a requested condition concerning a service rendered to the user via the computational resource(s), allocating at least one of a plurality of communication schemes to the computational resource(s).

### (Mode 32)

A program causing a controller for controlling a node to execute:

based on a requested condition concerning a service rendered to a user via a computational resource(s) allocated to the user, allocating at least one of a plurality of communication schemes to the computational resource(s); and

informing the node connected to the computational resource(s) about the allocated communication scheme.

The disclosures of the above mentioned Patent literatures are to be incorporated herein by reference. The exemplary embodiments or examples may be modified or adjusted within the concept of the total disclosures of the present invention, inclusive of claims, based on the fundamental technical concept of the invention. A wide variety of combinations or selections of elements herein disclosed (elements of claims, exemplary embodiments, examples and drawings) may be made within the context of the claims of the present invention. That is, the present invention may include a wide variety of changes or corrections that may occur to those skilled in the art in accordance with the total disclosures inclusive of the claims and the drawings as well as the technical concept of the invention. In particular, it should be understood that any optional numerical figures or sub-ranges contained in the ranges of numerical values set out herein ought to be construed to be specifically stated even in the absence of explicit statements.

### REFERENCE SIGNS LIST

1 allocation unit
2 computational resource
3 network
4 controller
5 packet processor
11 identification unit
12, 41, 401 control unit
13, 43, 403 policy DB (Database)
14, 44, 404 user DB
42, 54, 402 communication unit
51, 501 network communication unit
52 controller communication unit
53 packet forwarding table
100 server
101 virtual switch
102 VM (Virtual Machine)
110 physical switch
121, 122 network
400 OFC (OpenFlow Controller)
500 OFS (OpenFlow Switch)
502 OFC communication unit
503 flow table
1011, 1021 port

What is claimed is:

1. A communication system, comprising:
a computational resource(s) allocated to a user; and
an allocation unit that allocates at least one of a plurality of communication schemes to the computational resource(s) based on a requested condition concerning a service rendered to the user via the computational resource(s).

2. The communication system according to claim 1, wherein
the allocation unit allocates to the computational resources a communication scheme out of the plurality of communication schemes that satisfies the requested condition.

3. The communication system according to claim 1, wherein
a network(s), associated with the plurality of communication schemes, comprises a first network and a second network; the second network having to perform, in addition to processing needed in communication making use of the first network, a packet processing conforming to a communication scheme associated, and
the allocation unit allocates a communication scheme associated with the first network to the computational resource(s) in case the communication scheme associated with the second network fails to satisfy the requested condition.

4. The communication system according to claim 1, wherein
a network(s), associated with the plurality of communication schemes, comprises a physical network and a virtual network constructed over the physical network, and
the allocation unit allocates a communication scheme associated with the virtual network to the computational resource(s) in case a communication scheme associated with the physical network fails to satisfy the requested condition.

5. The communication system according to claim 1, wherein
the allocation unit allocates at least one of the plurality of communication schemes to the computational resource(s) depending on the requested condition and on a communication status of a network(s) associated with the plurality of communication schemes.

6. The communication system according to claim 1, wherein
the allocation unit allocates at least one of the plurality of communication schemes to the computational resource(s) in response to occurrence of communication related to the computational resource(s).

7. The communication system according to claim 1, wherein
the allocation unit allocates at least one of the plurality of communication schemes to the computational resource(s) in response to start of the service.

8. The communication system according to claim 1, wherein
the allocation unit changes allocation of a communication scheme in response to change of the requested condition corresponding to the user.

9. The communication system according to claim 1, wherein
the allocation unit changes allocation of a communication scheme in response to a request for changing the allocated communication scheme.

10. The communication system according to claim 1, comprising:
a controller that decides a communication scheme to be allocated to the computational resource(s) and that issues a notification to the allocation unit about the decided communication scheme, wherein
the allocation unit allocates at least one of the plurality of communication schemes to the computational resource(s) in accordance with the notification.

11. A node, comprising:
an identification unit that identifies a requested condition concerning a service rendered to a user via a computational resource(s) allocated to the user; and
a control unit that allocates at least one of a plurality of communication schemes to the computational resource(s) based on the requested condition.

12. The node according to claim 11, wherein
the control unit allocates to the computational resources a communication scheme out of the plurality of communication schemes that satisfies the requested condition.

13. The node according to claim 11, wherein
a network(s), associated with the plurality of communication schemes, comprises a first network and a second network; the second network having to perform, in addition to processing needed in communication making use of the first network, a packet processing conforming to a communication scheme associated, and
the control unit allocates a communication scheme associated with the first network to the computational resources in case the communication scheme associated with the second network fails to satisfy the requested condition.

14. The node according to claim 11, wherein
a network(s), associated with the plurality of communication schemes, comprises a physical network and a virtual network constructed over the physical network, and
the control unit allocates a communication scheme associated with the physical network to the computational resource(s) in case a communication scheme associated with the virtual network fails to satisfy the requested condition.

15. The node according to claim 11, wherein
the control unit allocates at least one of the plurality of communication schemes to the computational resource(s) depending on the requested condition and on a communication status of a network(s) associated with the plurality of communication schemes.

16. The node according to claim 11, wherein
the control unit allocates at least one of the plurality of communication schemes to the computational resource(s) in response to occurrence of communication related to the computational resource(s).

17. The node according to claim 11, wherein
the control unit allocates at least one of the plurality of communication schemes to the computational resource(s) in response to start of the service.

18. The node according to claim 11, wherein
the control unit changes allocation of a communication scheme in response to change of the requested condition corresponding to the user.

19. The node according to claim 11, wherein
the control unit changes allocation of a communication scheme in response to a request for changing the allocated communication scheme.

20. A controller, comprising:
an allocation unit that allocates at least one of a plurality of communication schemes to a computational resource(s), allocated to a user, based on a requested condition concerning a service rendered to the user via the computational resource(s); and
a communication unit that informs a node connected to the computational resource(s) about the allocated communication scheme.

21. The controller according to claim 20, wherein
the allocation unit allocates to the computational resources a communication scheme out of the plurality of communication schemes that satisfies the requested condition.

22. The controller according to claim 20, wherein
network(s), associated with the plurality of communication schemes, comprises a first network and a second network; the second network having to perform, in addition to processing needed in communication making use of the first network, a packet processing conforming to a communication scheme associated, and
the allocation unit allocates a communication scheme associated with the first network to the computational resource(s) in case the communication scheme associated with the second network fails to satisfy the requested condition.

23. The controller according to claim 20, wherein
a network(s), associated with the plurality of communication schemes, comprises a physical network and a virtual network constructed over the physical network, and
the allocation unit allocates a communication scheme associated with the physical network to the computational resource(s) in case a communication scheme associated with the virtual network fails to satisfy the requested condition.

24. The controller according to claim 20, wherein
the allocation unit allocates at least one of the plurality of communication schemes to the computational resource(s) depending on the requested condition and on a communication status of a network(s) associated with the plurality of communication schemes.

25. The controller according to claim 20, wherein
the allocation unit allocates at least one of the plurality of communication schemes to the computational resource(s) in response to occurrence of communication related to the computational resource(s).

26. The controller according to claim 20, wherein
the allocation unit allocates at least one of the plurality of communication schemes to the computational resource(s) in response to start of the service.

27. The controller according to claim 20, wherein
the allocation unit changes allocation of a communication scheme in response to change of the requested condition corresponding to the user.

28. The controller according to claim 20, wherein
the allocation unit changes allocation of a communication scheme in response to a request for changing the allocated communication scheme.

29. A communication method, comprising:
identifying a requested condition concerning a service rendered to a user via a computational resource(s) allocated to the user; and
allocating at least one of a plurality of communication schemes to the computational resource(s) based on the requested condition.

30. A communication method, comprising:
allocating at least one of a plurality of communication schemes to a computational resource(s) allocated to a user based on a requested condition concerning a service rendered to the user via the computational resource(s); and
informing a node connected to the computational resource(s) about the allocated communication scheme.

31. A non-transitory computer-readable recording medium storing a program that causes a node, connected to a computational resource(s) allocated to a user, to execute:
identifying a requested condition concerning a service rendered to the user via the computational resource(s); and
allocating at least one of a plurality of communication schemes to the computational resource(s) based on the requested condition.

32. A non-transitory computer-readable recording medium storing a program that causes a controller for controlling a node to execute:
based on a requested condition concerning a service rendered to a user via a computational resource(s) allocated to the user, allocating at least one of a plurality of communication schemes to the computational resource(s); and
informing the node connected to the computational resource(s) about the allocated communication scheme.

33. A communication system, comprising:
a node connected to a computational resource(s) allocated to a user; and
a controller that controls communication mediated by the node, wherein
the controller comprises:
an allocation unit that allocates at least one of a plurality of communication schemes to the computational resource(s) based on a requested condition concerning a service rendered to the user via the computational resource(s); and
a communication unit that informs the node about the allocated communication scheme.
